(19) United States
(12) Patent Application Publication
(10) Pub. No.: US 2026/0113806 A1
(43) Pub. Date: Apr. 23, 2026

(54) CONNECTED MODE DISCONTINUOUS RECEPTION (C-DRX) ENHANCEMENT WITH WAKEUP SIGNAL FOR SIDELINK COMMUNICATION

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Giovanni CHISCI, San Diego, CA (US); Changlong XU, Beijing (CN); Shaozhen GUO, Beijing (CN); Luanxia YANG, Beijing (CN); Hao XU, Beijing (CN)

(21) Appl. No.: 19/117,018

(22) PCT Filed: Nov. 23, 2022
(86) PCT No.: PCT/CN2022/133776

§ 371 Date: Mar. 28, 2025

(51) Int. Cl. H04W 76/28; H04W 52/02; H04W 72/25

(52) U.S. Cl. CPC H04W 76/28; H04W 52/0235; H04W 72/25

(57) ABSTRACT

Apparatus, methods, and computer-readable media for connected mode discontinuous reception (DRX) enhancement with wakeup signal for sidelink communication are disclosed herein. A receiver user equipment (UE) may receive a sidelink DRX configuration that configures the receiver UE with a first sidelink DRX configuration or a second sidelink DRX configuration, the first sidelink DRX configuration configuring the receiver UE to transition into a sleep state and the second sidelink DRX configuration configuring the receiver UE to transition into a wakeup state, both upon indication of the sidelink WUS. The receiver UE transitions into the sleep state in a second DRX cycle based on the sidelink WUS being received within a sidelink WUS monitoring occasion and the first sidelink DRX configuration, or transitions into the wakeup state based on the sidelink WUS being received within the sidelink WUS monitoring occasion and the second sidelink DRX configuration.

### BACKGROUND

### Technical Field

The present disclosure relates generally to communication systems, and more particularly, to connected mode discontinuous reception (C-DRX) enhancement with wakeup signal for sidelink communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology.

These improvements may also be applicable to other multi-access technologies and the telecommunication standards that employ these technologies. For example, some aspects of wireless communication include direct communication between devices, such as device-to-device (D2D), vehicle-to-everything (V2X), and the like. There exists a need for further improvements in such direct communication between devices. Improvements related to direct communication between devices may be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various aspects and features related to power saving in wireless communication systems are described. Some aspects described herein allow supporting multiple power and/or spectrum efficient modes/configurations in wireless communication devices, e.g., such as IoT devices, to facilitate low power operations and/or reduce power consumption.

In Uu link power saving techniques, a downlink control channel based wakeup signal (WUS) can be configured at a configurable offset ahead of a discontinuous reception (DRX) active duration cycle for an improvement in power savings. A connected mode DRX (C-DRX) mechanism is also introduced in sidelink communication to save power. However, there may be unnecessary wakeup events in sidelink communication, which may adversely impact the power efficiency during C-DRX operation.

The subject technology provides for facilitating C-DRX enhancement with WUS for sidelink communication to help avoid such unnecessary wakeup events. For example, a receiver UE can be configured with a first sidelink DRX configuration that configures the receiver UE to transition into a sleep state upon indication of a sidelink WUS, or configured with a second sidelink DRX configuration that configures the receiver UE to transition into a wakeup state upon indication of the sidelink WUS. Upon detecting the WUS, the receiver UE transitions into the sleep state based on the sidelink WUS being received within a sidelink WUS monitoring occasion and the receiver UE is configured with the first sidelink DRX configuration. Alternatively, the receiver UE transitions into the wakeup state based on the sidelink WUS being received within the sidelink WUS monitoring occasion and the receiver UE is configured with the second sidelink DRX configuration.

In an aspect of the disclosure, a method, a computer-readable medium, and an apparatus are provided. The apparatus may be a receiver user equipment (UE). The apparatus is configured to receive, via the transceiver, from a transmitter UE, a sidelink discontinuous reception (DRX) configuration. The apparatus also is configured to determine whether the sidelink DRX configuration configures the receiver UE with a first sidelink DRX configuration or a second sidelink DRX configuration, the first sidelink DRX configuration configuring the receiver UE to transition into a sleep state upon indication of a sidelink wake-up signal (WUS), the second sidelink DRX configuration configuring the receiver UE to transition into a wakeup state upon indication of the sidelink WUS. The apparatus also is configured to determine whether the sidelink WUS is received within a sidelink WUS monitoring occasion in a first DRX cycle based on the sidelink DRX configuration. The apparatus is also configured to transition into the sleep state in a second DRX cycle based on the sidelink WUS being received within the sidelink WUS monitoring occasion and the sidelink DRX configuration configuring the receiver UE with the first sidelink DRX configuration. The apparatus is also configured to transition into the wakeup state in the second DRX cycle based on the sidelink WUS being received within the sidelink WUS monitoring occasion and the sidelink DRX configuration configuring the receiver UE with the second sidelink DRX configuration.

In an aspect of the disclosure, a method, a computer-readable medium, and an apparatus are provided. The apparatus may be a transmitter UE. The apparatus is configured to determine a first sidelink DRX configuration to configure a receiver UE to transition into a sleep state upon indication of a sidelink WUS and determine a second sidelink DRX configuration to configure the receiver UE to transition into a wakeup state upon indication of the sidelink WUS. The apparatus is also configured to transmit, via the transceiver, to the receiver UE, a sidelink DRX configuration to configure the receive UE with the first sidelink DRX configuration or the second sidelink DRX configuration. The apparatus is also configured to transmit, via the transceiver, to the receiver UE, the sidelink WUS within a sidelink WUS monitoring occasion in a first DRX cycle based on the sidelink DRX configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 illustrates example aspects of a sidelink slot structure.

FIG. 4 is a diagram illustrating an example of a base station and user equipment (UE) in an access network.

FIG. 5 illustrates an example of sidelink communication between wireless devices, in accordance with one or more of aspects of the present disclosure.

FIG. 6 illustrates example discontinuous reception (DRX) cycles at a PC-5 interface.

FIG. 7 illustrates an example of a sidelink communication between wireless devices of a connected mode discontinuous reception (C-DRX) enhancement with wakeup signal for sidelink communication, in accordance with one or more of aspects of the present disclosure.

FIG. 8 is a diagram illustrating an example of DRX cycles with wakeup signal (WUS) monitoring occasions, in accordance with one or more of aspects of the present disclosure.

FIG. 9 is a diagram illustrating another example of DRX cycles with sidelink control information (SCI) transmitted in wakeup signal (WUS) monitoring occasions, in accordance with one or more of aspects of the present disclosure.

FIG. 10A is a diagram illustrating an example of DRX cycles with WUS monitoring occasions, in accordance with one or more of aspects of the present disclosure.

FIG. 10B is a diagram illustrating another example of DRX cycles with SCI transmitted in WUS monitoring occasions embedded in DRX on-duration instances, in accordance with one or more of aspects of the present disclosure.

FIG. 11A is a diagram illustrating an example of sidelink WUS monitoring occasions embedded in a DRX on-duration, in accordance with one or more of aspects of the present disclosure.

FIG. 11B is a diagram illustrating an example of sidelink WUS monitoring occasions outside of a DRX on-duration, in accordance with one or more of aspects of the present disclosure.

FIG. 12 is a diagram illustrating an example of DRX cycles with a sidelink WUS associated with multiple successive DRX on-duration instances, in accordance with one or more of aspects of the present disclosure.

FIG. 13 is a diagram illustrating an example of DRX cycles with physical sidelink feedback channel (PSFCH) transmitted in WUS monitoring occasions, in accordance with one or more of aspects of the present disclosure.

FIG. 14 is a diagram illustrating another example of DRX cycles with PSFCH transmitted in WUS monitoring occasions, in accordance with one or more of aspects of the present disclosure.

FIG. 15 is a diagram illustrating still another example of DRX cycles with PSFCH transmitted in WUS monitoring occasions, in accordance with one or more of aspects of the present disclosure.

FIG. 16 is a flowchart illustrating a process of wireless communication that supports C-DRX enhancement with wakeup signal for sidelink communication at a receiver UE in accordance with some aspects of the present disclosure.

FIG. 17 is a flowchart illustrating a process of wireless communication that supports C-DRX enhancement with wakeup signal for sidelink communication at a transmitter UE in accordance with some aspects of the present disclosure.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

A user equipment (UE) may be configured by a base station for a discontinuous reception (DRX) mode. When there is no data to be transmitted between the UE and base station in either direction, e.g., no uplink or downlink transmissions, the UE may enter the DRX mode in which the UE may monitor a control channel discontinuously using a sleep and wake cycle. DRX conserves battery power at the UE for improved power efficiency. Without DRX, the UE may monitor the control channel in every slot/subframe to check whether there is data for the UE. Continuous monitoring of the control channel places a demand on the UE's battery power.

The DRX configuration may be configured by the network in radio resource control (RRC) signaling from a base station, e.g. in an RRC Connection Setup request or an RRC connection reconfiguration request. A DRX configuration may include the configuration of any of a number of timers and values, e.g., any of an On-duration Timer, a DRX Inactivity Timer, a DRX DL Retransmission Timer, a DRX UL Retransmission Timer, a DRX Long Cycle, a value of the DRX Start Offset, a DRX Short Cycle Timer, and/or a DRX Short Cycle, etc. A DRX Cycle may comprise a periodic repetition of On-duration in which the UE monitors physical downlink control channel (PDCCH) and an OFF Duration, which may be referred to as a DRX opportunity. During the OFF duration, the UE does not monitor for PDCCH. The UE may enter a sleep mode or low power mode in which the UE minimizes power consumption by shutting down a radio frequency (RF) function without detecting communication from the base station.

As an example, a DRX Inactivity Timer may indicate a time, e.g., in terms of transmission time interval (TTI) duration, after the UE successfully decodes PDCCH when the UE may again enter the OFF Duration. An On-duration Timer may indicate an amount of time during which the UE monitors for communication from the base station when the UE wakes up from the OFF duration in DRX Cycle. For example, the On-duration Timer may give the number of consecutive PDCCH subframe(s) be monitored/decoded when the UE wakes up from the OFF duration in DRX Cycle. The UE may be considered to be in a DRX active time if at least one associated timer is running (e.g., the DRX On-duration Timer, the DRX Inactivity Timer, and/or the DRX Retransmission Timer) and the UE is monitoring for communication from the base station.

A connected mode DRX (C-DRX) mechanism is introduced to reduce power consumption by allowing a UE to periodically enter into a power-saving mode (or a sleep state), where the UE can turn off major circuits when there is no expectation of a packet arrival. However, the UE also wakes up periodically to monitor for any packet arrivals. In order to prevent any loss of data, the UE and the network may need to have a predefined agreement about the UE's periodic transition between sleep and wakeup states. Typically, the UE receives DRX configuration parameters in a downlink radio resource control (RRC) configuration message sent by the network.

A wake-up signal (WUS) is introduced to further reduce power consumption by the UE, where the WUS is a special downlink control signal (e.g., physical downlink control channel (PDCCH)) sent by the network before a DRX active duration to indicate whether the UE should stay active to receive new data or skip a current DRX active duration until a next DRX active duration. The WUS may be sent outside of the DRX active duration by using a group-common downlink control information (DCI) with a cyclic redundancy check (CRC) scrambled by a radio network temporary identifier (RNTI) referred to as a power saving RNTI (PS-RNTI). The DCI may have a designated format (e.g., DCI format 2_6), which can carry one or more information blocks with each information block intended for a specific UE (e.g., block number 1, block number 2, . . . , block number N).

In Uu link power saving techniques, a PDCCH-based WUS is configured at a configurable offset ahead of a DRX active duration cycle for an improvement in power savings. The C-DRX mechanism is also introduced in sidelink communication to save power. Improvement in power efficiency during C-DRX operation with reduced likelihood of unnecessary wake-up events in sidelink communication may be desirable.

The subject technology provides for facilitating C-DRX enhancement with WUS for sidelink communication. In some implementations, a receiver UE for facilitating C-DRX enhancement with WUS can receive a sidelink DRX configuration, and determine whether the sidelink DRX configuration configures the receiver UE with a first sidelink DRX configuration or a second sidelink DRX configuration, in which the first sidelink DRX configuration configures the receiver UE to transition into a sleep state upon indication of a sidelink WUS, and the second sidelink DRX configuration configures the receiver UE to transition into a wakeup state upon indication of the sidelink WUS. The UE can determine whether the sidelink WUS is received within a sidelink WUS monitoring occasion in a first DRX cycle based on the sidelink DRX configuration. The UE also can transition into the sleep state in a second DRX cycle based on the sidelink WUS being received within the sidelink WUS monitoring occasion and the sidelink DRX configuration configuring the receiver UE with the first sidelink DRX configuration. The UE also can transition into the wakeup state in the second DRX cycle based on the sidelink WUS being received within the sidelink WUS monitoring occasion and the sidelink DRX configuration configuring the receiver UE with the second sidelink DRX configuration.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

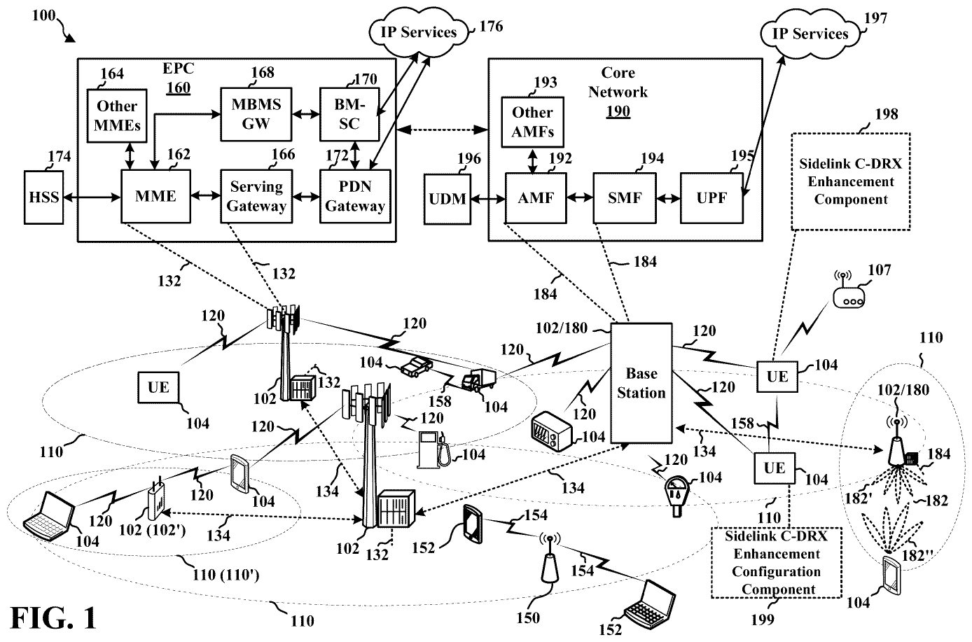

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. Some wireless communication may be exchanged directly between wireless devices based on sidelink. The communication may be based on vehicle-to-anything (V2X) or other device-to-device (D2D) communication, such as Proximity Services (ProSe), etc. Sidelink communication may be exchanged based on a PC5 interface, for example. For example, the D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

In sidelink communication, control information may be indicated by a transmitting UE in multiple SCI parts. The SCI may indicate resources that the UE intends to use, for example, for a sidelink transmission. The UE may transmit a first part of control information indicating information about resource reservation in a PSCCH region, and may transmit a second part of the control information in a PSSCH region. For example, a first stage control (e.g., SCI-1) may be transmitted on a PSCCH and may contain information for resource allocation and information related to the decoding of a second stage control (e.g., SCI-2). The second stage control (SCI-2) may be transmitted on a PSSCH and may contain information for decoding data (SCH). Therefore, control information may be indicated through a combination of the first SCI part included in the PSCCH region (e.g., the SCI-1) and the second SCI part included in the PSSCH region (e.g., the SCI-2). In other aspects, control information may be indicated in a media access control (MAC) control element (MAC-CE) portion of the PSSCH.

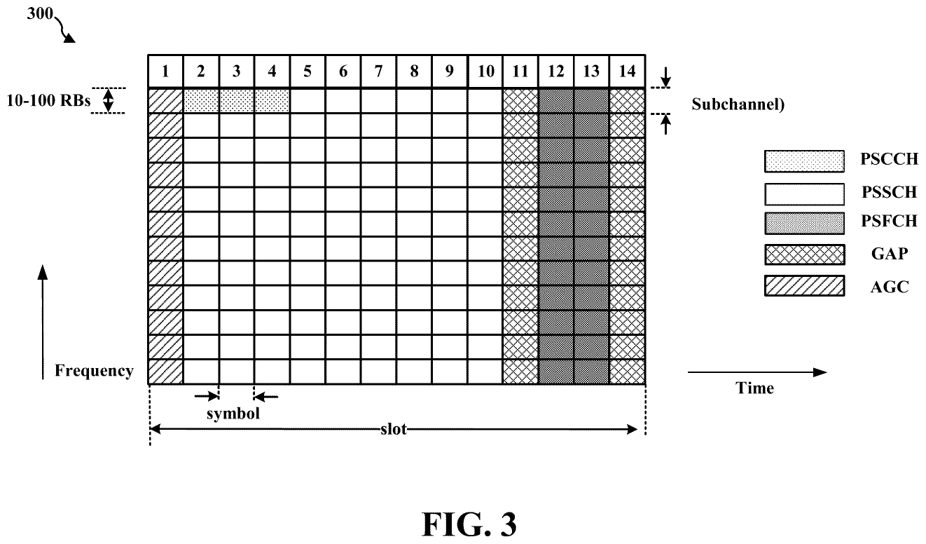

Some examples of sidelink communication may include vehicle-based communication such as vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as V2X communications. As an example, in FIG. 1, a UE 104, e.g., a transmitting Vehicle User Equipment (VUE) or other UE 104, may be configured to transmit messages directly to another UE 104. The communication may be based on V2X or other D2D communication, such as Proximity Services (ProSe), etc. Communication based on V2X and/or D2D may also be transmitted and received by other transmitting and receiving devices, such as Road Side Unit (RSU) 107, etc. Aspects of the communication may be based on PC5 or sidelink communication e.g., as described in connection with the example in FIG. 3. Although the following description may provide examples for V2X/D2D communication in connection with 5G NR, the concepts described herein may be applicable to other similar areas, such as LTE, LTE-A, CDMA, GSM, and other wireless technologies.

Further, although the present disclosure may focus on vehicle-to-pedestrian (V2P) communication and pedestrian-to-vehicle (P2V) communication, the concepts and various aspects described herein may be applicable to other similar areas, such as D2D communication, IoT communication, vehicle-to-everything (V2X) communication, or other standards/protocols for communication in wireless/access networks.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may include a sidelink C-DRX enhancement component 198, which is configured to receive, from a transmitter UE, a sidelink DRX configuration. The C-DRX enhancement component 198 is also configured to determine whether the sidelink DRX configuration configures the receiver UE with a first sidelink DRX configuration or a second sidelink DRX configuration, the first sidelink DRX configuration configuring the receiver UE to transition into a sleep state upon indication of a sidelink WUS, the second sidelink DRX configuration configuring the receiver UE to transition into a wakeup state upon indication of the sidelink WUS. In other aspects, the sidelink C-DRX enhancement component 198 is configured to determine whether the sidelink WUS is received within a sidelink WUS monitoring occasion in a first DRX cycle based on the sidelink DRX configuration. The sidelink C-DRX enhancement component 198 is also configured to transition into the sleep state in a second DRX cycle based on the sidelink WUS being received within the sidelink WUS monitoring occasion and the sidelink DRX configuration configuring the receiver UE with the first sidelink DRX configuration. The sidelink C-DRX enhancement component 198 is also configured to transition into the wakeup state in the second DRX cycle based on the sidelink WUS being received within the sidelink WUS monitoring occasion and the sidelink DRX configuration configuring the receiver UE with the second sidelink DRX configuration.

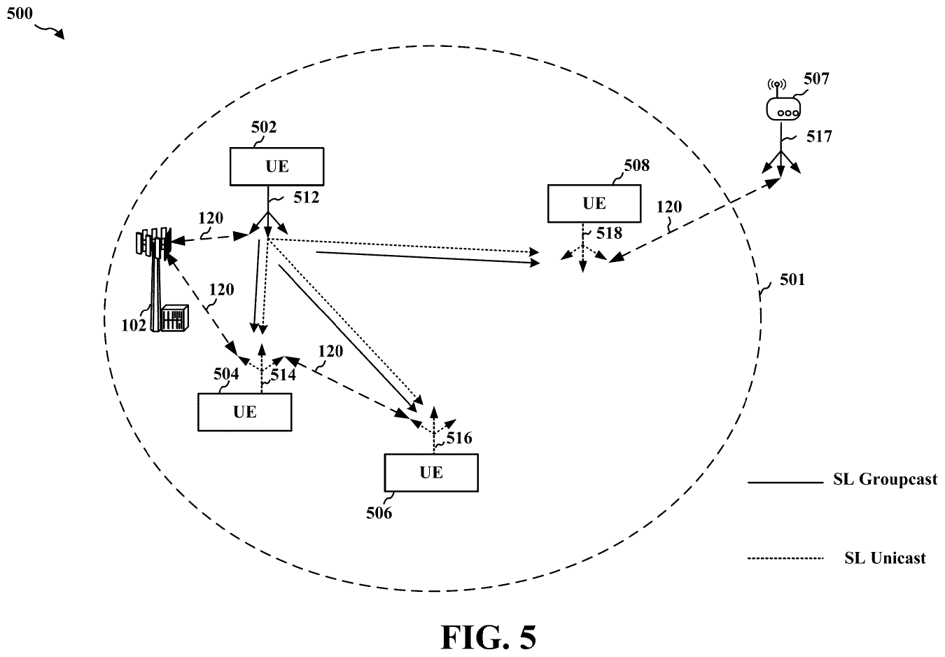

In certain aspects, the other UE 104 may include a sidelink C-DRX enhancement configuration component 199, which is configured to determine a first sidelink DRX configuration to configure a receiver UE to transition into a sleep state upon indication of a sidelink WUS. The sidelink C-DRX enhancement configuration component 199 is also configured to determine a second sidelink DRX configuration to configure the receiver UE to transition into a wakeup state upon indication of the sidelink WUS. In other aspects, the sidelink C-DRX enhancement configuration component 199 is configured to transmit, via the transceiver, to the receiver UE, a sidelink DRX configuration to configure the receive UE with the first sidelink DRX configuration or the second sidelink DRX configuration. The sidelink C-DRX enhancement configuration component 199 is also configured to transmit, via the transceiver, to the receiver UE, the sidelink WUS within a sidelink WUS monitoring occasion in a first DRX cycle based on the sidelink DRX configuration. Further related aspects and features are described in more detail in connection with FIGS. 5-18. Although the following description may be focused on 5G NR, the concepts described herein may be applicable to other similar areas, such as LTE, LTE-A, CDMA, GSM, and other wireless technologies.

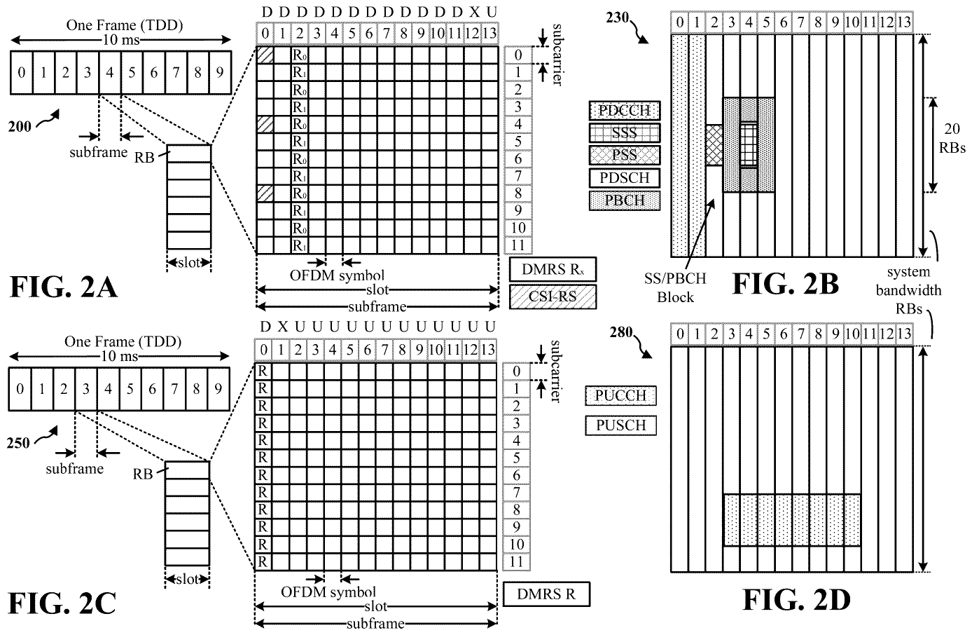

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

FIG. 3 illustrates example diagram 300 illustrating non-limiting examples of time and frequency resources that may be used for wireless communication based on sidelink. In some examples, the time and frequency resources may be based on a slot structure. In other examples, a different structure may be used. The slot structure may be within a 5G/NR frame structure in some examples. Although the following description may be focused on 5G NR, the concepts described herein may be applicable to other similar areas, such as LTE, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single slot transmission, e.g., which may correspond to a 0.5 ms transmission time interval (TTI).

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. Diagram 300 also illustrates multiple subchannels, where each subchannel may include multiple RBs. For example, one subchannel in sidelink communication may include 10-100 RBs. As illustrated in FIG. 3, the first symbol of a subframe may be a symbol for automatic gain control (AGC). Some of the REs may include control information, e.g., along with PSCCH and/or PSSCH. The control information may include Sidelink Control Information (SCI). For example, the PSCCH can include a first-stage SCI. A PSCCH resource may start at a first symbol of a slot, and may occupy 1, 2 or 3 symbols. The PSCCH may occupy up to one subchannel with the lowest subcarrier index. FIG. 3 also illustrates symbol(s) that may include PSSCH. The symbols in FIG. 3 that are indicated for PSCCH or PSSCH indicate that the symbols include PSCCH or PSSCH REs. Such symbols corresponding to PSSCH may also include REs that include a second-stage SCI and/or data. At least one symbol may be used for feedback (e.g., PSFCH), as described herein. As illustrated in FIG. 3, symbols 12 and 13 are indicated for PSFCH, which indicates that these symbols include PSFCH REs. In some aspects, symbol 12 of the PSFCH may be a duplication of symbol 13. A gap symbol prior to and/or after the feedback may be used for turnaround between reception of data and transmission of the feedback. As illustrated in FIG. 3, symbol 10 includes a gap symbol to enable turnaround for feedback in symbol 11. Another symbol, e.g., at the end of the slot (symbol 14) may be used as a gap. The gap enables a device to switch from operating as a transmitting device to prepare to operate as a receiving device, e.g., in the following slot. Data may be transmitted in the remaining REs, as illustrated. The data may include the data message described herein. The position of any of the PSCCH, PSSCH, PSFCH, and gap symbols may be different than the example illustrated in FIG. 3.

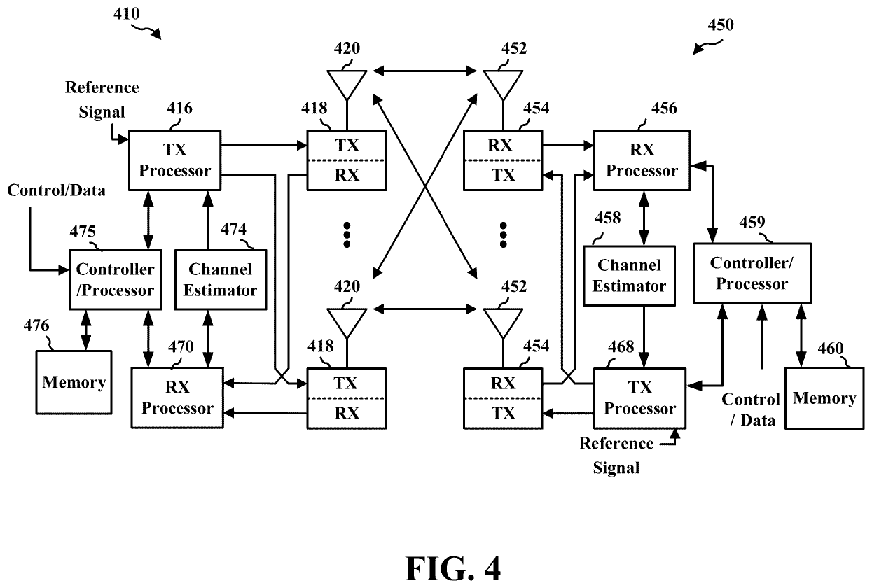

FIG. 4 is a block diagram of a base station 410 in communication with a UE 450 in an access network. In the DL, IP packets from the EPC 160 may be provided to a controller/processor 475. The controller/processor 475 implements layer 3 and layer 2 functionality. Layer 4 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 416 and the receive (RX) processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418TX. Each transmitter 418TX may modulate an RF carrier with a respective spatial stream for transmission.

At the UE 450, each receiver 454RX receives a signal through its respective antenna 452. Each receiver 454RX recovers information modulated onto an RF carrier and provides the information to the receive (RX) processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 4 and layer 2 functionality.

The controller/processor 459 can be associated with a memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets from the EPC 160. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454TX. Each transmitter 454TX may modulate an RF carrier with a respective spatial stream for transmission.

The UL transmission is processed at the base station 410 in a manner similar to that described in connection with the receiver function at the UE 450. Each receiver 418RX receives a signal through its respective antenna 420. Each receiver 418RX recovers information modulated onto an RF carrier and provides the information to a RX processor 470.

The controller/processor 475 can be associated with a memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets from the UE 450. IP packets from the controller/processor 475 may be provided to the EPC 160. The controller/processor 475 is also responsible for error detection using an ACK and/or NACK protocol to support HARQ operations.

At least one of the TX processor 468, the RX processor 456, and the controller/processor 459 may be configured to perform aspects in connection with the sidelink C-DRX enhancement component 198 of FIG. 1.

At least one of the TX processor 416, the RX processor 470, and the controller/processor 475 may be configured to perform aspects in connection with the sidelink C-DRX enhancement configuration component 199 of FIG. 1.

A UE may be configured by a base station for a DRX mode at a Uu interface. When there is no data to be transmitted between the UE and base station in either direction, e.g., no uplink or downlink transmissions at the Uu interface, the UE may enter the DRX mode in which the UE may monitor a control channel discontinuously using a sleep and wake cycle. DRX conserves battery power at the UE for improved power efficiency. Without DRX, the UE may monitor the control channel in every slot/subframe to check whether there is data for the UE. Continuous monitoring of the control channel places a demand on the UE's battery power. A sidelink DRX configuration may be configured for a PC5 interface by the network in RRC signaling from a base station, e.g. in an RRC Connection Setup request or an RRC connection reconfiguration request. The sidelink DRX configuration may include the configuration of any of a number of timers and values, e.g., any of a sidelink On duration Timer, a sidelink DRX Inactivity Timer, a sidelink DRX HARQ Retransmission Timer, a value of the sidelink DRX Start Offset, and/or a sidelink DRX Cycle, etc. A sidelink DRX cycle may include a sidelink DRX active duration. The sidelink DRX active duration may refer to a duration of time in which a UE operating as a transmitter is active or a UE operating as a receiver is active. The sidelink DRX cycle also may include a periodic repetition of sidelink on duration in which the UE monitors PSCCH (e.g., SCI-1 and/or SCI-2), and an OFF Duration, which may be referred to as a DRX opportunity. During the OFF duration, the UE does not monitor for PSCCH for scheduling on sidelink. The UE may enter a sleep mode or low power mode in which the UE minimizes power consumption by shutting down a radio frequency (RF) function without detecting communication from the base station.

As an example of a DRX at a Uu interface, a DRX Inactivity Timer may indicate a time, e.g., in terms of TTI duration, after the UE successfully decodes PDCCH when the UE may again enter the OFF Duration. An On duration Timer may indicate an amount of time during which the UE monitors for communication from the base station when the UE wakes up from the OFF duration in DRX Cycle. For example, the On duration Timer may give the number of consecutive PDCCH subframe(s) be monitored/decoded when the UE wakes up from the OFF duration in DRX Cycle. The UE may be considered to be in a DRX active time if at least one associated timer is running (e.g., the DRX on-duration Timer, the DRX Inactivity Timer, and/or the DRX Retransmission Timer) and the UE is monitoring for communication from the base station.

In an example of a sidelink DRX at a PC5 interface, a sidelink DRX Inactivity Timer may indicate a time, e.g., in terms of slot or subframe duration, after the UE successfully decodes PSCCH to when the UE may again enter the OFF Duration. A sidelink On duration Timer may indicate an amount of time during which the UE monitors for communication from other UEs on sidelink or PC5 interface when the UE wakes up from the OFF duration in DRX Cycle. For example, the On duration Timer may give the number of consecutive subframe(s) or slot(s) (e.g., physical slot(s) or logical slot(s), where the logical slots are the slots available for sidelink communications with data) be monitored/decoded when the UE wakes up from the OFF duration in DRX Cycle. The UE may be considered to be in a DRX active time if at least one associated timer is running (e.g., the DRX on-duration Timer, the DRX Inactivity Timer, and/or the DRX Retransmission Timer or HARQ Retransmission timer) and the UE is monitoring for communication on sidelink (i.e., PC5 interface).

A connected mode DRX (C-DRX) mechanism is introduced to reduce power consumption by allowing a UE to periodically enter into a power-saving mode (or a sleep state), where the UE can turn off major circuits when there is no expectation of a packet arrival. However, the UE also wakes up periodically to monitor for any packet arrivals. In order to prevent any loss of data, the UE and the network may need to have a predefined agreement about the UE's periodic transition between sleep and wakeup states. Typically, the UE receives DRX configuration parameters in a downlink RRC configuration message sent by the network.

A wake-up signal (WUS) is introduced to further reduce power consumption by the UE, where the WUS is a special downlink control signal (e.g., physical downlink control channel (PDCCH)) sent by the network before a DRX active duration to indicate whether the UE should stay active to receive new data or skip a current DRX active duration until a next DRX active duration. The WUS may be sent outside of the DRX active duration by using a group-common downlink control information (DCI) with a cyclic redundancy check (CRC) scrambled by a radio network temporary identifier (RNTI) referred to as a power saving RNTI (PS-RNTI). The DCI may have a designated format (e.g., DCI format 2_6), which can carry one or more information blocks with each information block intended for a specific UE (e.g., block number 1, block number 2, . . . , block number N).

In Uu link power saving techniques, a PDCCH-based WUS is configured at a configurable offset ahead of a DRX active duration cycle for an improvement in power savings. The C-DRX mechanism is also introduced in sidelink communication to save power. Improvement in power efficiency during C-DRX operation with reduced likelihood of unnecessary wake-up events in sidelink communication may be desirable.

The subject technology provides for facilitating C-DRX enhancement with WUS for sidelink communication. In some implementations, a receiver UE for facilitating C-DRX enhancement with WUS can receive a sidelink DRX configuration, and determine whether the sidelink DRX configuration configures the receiver UE with a first sidelink DRX configuration or a second sidelink DRX configuration, in which the first sidelink DRX configuration configures the receiver UE to transition into a sleep state upon indication of a sidelink WUS, and the second sidelink DRX configuration configures the receiver UE to transition into a wakeup state upon indication of the sidelink WUS. The UE can determine whether the sidelink WUS is received within a sidelink WUS monitoring occasion in a first DRX cycle based on the sidelink DRX configuration. The UE also can transition into the sleep state in a second DRX cycle based on the sidelink WUS being received within the sidelink WUS monitoring occasion and the sidelink DRX configuration configuring the receiver UE with the first sidelink DRX configuration. The UE also can transition into the wakeup state in the second DRX cycle based on the sidelink WUS being received within the sidelink WUS monitoring occasion and the sidelink DRX configuration configuring the receiver UE with the second sidelink DRX configuration.

In other implementations, a transmitter UE may determine a first sidelink DRX configuration to configure a receiver UE to transition into a sleep state upon indication of a sidelink WUS, and determine a second sidelink DRX configuration to configure the receiver UE to transition into a wakeup state upon indication of the sidelink WUS. The transmitter UE may transmit, via the transceiver, to the receiver UE, a sidelink DRX configuration to configure the receive UE with the first sidelink DRX configuration or the second sidelink DRX configuration. In some implementations, the transmitter UE also may transmit, via the transceiver, to the receiver UE, the sidelink WUS within a sidelink WUS monitoring occasion in a first DRX cycle based on the sidelink DRX configuration.

FIG. 5 illustrates an example 500 of sidelink communication between wireless devices. The communication may be based on a slot structure comprising aspects described in connection with FIG. 3 or another sidelink structure. Although the example in FIG. 5 is described for the UEs 502, 504, 506, 508, aspects may be applied to other wireless devices configured for communication based on sidelink, such as an RSU, an IAB node, etc.

As illustrated in FIG. 5, a UE 502 may transmit a sidelink transmission that includes a control information (e.g., SCI) and/or a corresponding data channel such as physical sidelink shared channel (PSSCH), that may be received by receiving UEs 504, 506, 508. As illustrated in FIG. 5, the sidelink transmission may be transmitted in a groupcast transmission to each of the UEs 504, 506 and 508 as belong to a common group or different groups. In other aspects, the sidelink transmission may be transmitted in a broadcast transmission to the UEs 504, 506 and 508. The SCI (e.g., SCI-2) may include information for decoding the corresponding data and the SCI (e.g., SCI-1) may also be used by receiving device to avoid interference by refraining from transmitting on the occupied resources during a data transmission. For example, the SCI (e.g., SCI-1) may reserve resources for sidelink communication. The number of slots, as well as the subchannels that will be occupied by the data transmission, may be indicated in SCI (e.g., SCI-1) from the transmitting device. The UEs 502, 504, 506, 508 may each be capable of operating as a transmitting device in addition to operating as a receiving device. Thus, the UEs 506, 508 are illustrated as transmitting transmissions 516 and 518. The transmissions 514, 516 or 518 may be broadcast or groupcast to nearby devices. For example, the UE 502 may transmit communication intended for receipt by other UEs within a required communication range 501 of the UE 502 (e.g., distance-based groupcast or connectionless groupcast). In other examples, the transmissions 514, 516, or 518 may be groupcast to nearby devices that a member of a group (e.g., connection-based groupcast). In other examples, the transmissions 514, 516, or 518 may be unicast from one UE to another UE. In some aspects, the UE 502 may be a group lead for a connection based groupcast. In other aspects, the UE 502 may be a cluster head for distance-based or connectionless groupcast. In other aspects, the UE 502 may be a scheduling UE for managing and/or supporting sidelink communications among the UEs (e.g., UEs 504, 506 or 508) in proximity. Additionally or alternatively, the RSU 507 may receive communication from and/or transmit communication to the UE 508.

The UE 502, 504, 506, 508 and/or the RSU 507 may include a sidelink C-DRX enhancement component, similar to the sidelink C-DRX enhancement component 198 described in connection with FIG. 1. The UE 502, 504, 506, 508 and/or the RSU 507 may additionally or alternatively include a sidelink C-DRX enhancement configuration component, similar to the sidelink C-DRX enhancement configuration component 199 described in connection with FIG. 1.

Resource allocation refers to how a resource is allocated to a device to use for transmitting a packet. In sidelink communication, resource allocation may be performed in a centralized manner (Mode 1) or a distributed manner (Mode 2). When operating using Mode 1, resource allocations for sidelink communication are determined by a base station. For example, the base station may transmit an indication to a UE that indicates the resources that are allocated to the UE to use to transmit sidelink communication (e.g., sidelink data packets to other UEs). When operating using Mode 2, the resource allocations for sidelink communication are determined by the communicating UE. For example, a transmitting UE may autonomously determine resource allocations for transmitting sidelink control and data to one or more receiving UEs. When operating using Mode 2 (e.g., in a distributed manner), the transmitting UE may determine the resources to use for communicating from a resource pool. A resource pool refers to a collection of time and/or frequency resources on which sidelink communication may occur.

As shown in FIG. 5, a transmitter (Tx) UE 502 and a receiver (Rx) UE 504 may communicate with one another via a sidelink. In some sidelink modes, a base station 102/180 may communicate with the Tx UE 502 via a first access link (not shown). Additionally, or alternatively, in some sidelink modes, the base station 102/180 may communicate with the Rx UE 504 via a second access link (not shown). The Tx UE 502 and/or the Rx UE 504 may correspond to one or more UEs described elsewhere herein, such as the UE 104 of FIG. 1. Thus, a direct link between UEs 104 (e.g., via a PC5 interface) may be referred to as a sidelink, and a direct link between a base station 102/180 and a UE 104 (e.g., via a Uu interface) may be referred to as an access link. Sidelink communications may be transmitted via the sidelink, and access link communications may be transmitted via the access link. An access link communication may be either a downlink communication (from a base station 102/180 to a UE 104) or an uplink communication (from a UE 104 to a base station 102/180).

As described above, the UE 502 may operate in Mode 1, in which resource selection and/or scheduling is performed by the base station 102/180. That is, in Mode 1, the base station 102/180 assigns resources for transmitting sidelink communications. In particular, the base station 102/180 may transmit downlink control information (DCI) (e.g., in DCI format 3_0) that indicates a resource allocation (e.g., time and/or frequency resources) and/or a transmission timing. In Mode 1, a MCS value for sidelink transmissions may be selected by a UE 502 (e.g., within limits set by the base station 102/180). Moreover, Mode 1 may support dynamic grants or configured grants for scheduling sidelink transmissions. The configured grants may be type 1 (e.g., which may be activated by the base station 102/180 via radio resource control (RRC) signaling) or type 2 (e.g., which may be activated by the base station 102/180 via DCI signaling).

As described above, the UE 502 may operate in Mode 2, in which resource selection and/or scheduling is performed by the UE 502. That is, the transmitting UE 502 may autonomously determine resources for sidelink transmissions. In this case, the transmitting UE 502 may perform channel sensing by performing blind decoding of all PSCCH channels in order to determine resources that are reserved for sidelink transmissions (e.g., by other transmitting UEs). In this way, the transmitting UE 502 may determine available resources, which may be reported to an upper layer of the transmitting UE 502 where resource usage is determined. The receiving UE 504 operates according to the same behavior in Mode 1 or Mode 2. In some aspects, the UE 502 may perform resource selection and/or scheduling by sensing channel availability for transmissions. For example, the UE 502 may measure a received signal strength indicator (RSSI) parameter (e.g., a sidelink-RSSI (S-RSSI) parameter) associated with various sidelink channels, may measure a reference signal received power (RSRP) parameter (e.g., a PSCCH-RSRP or PSSCH-RSRP parameter) associated with various sidelink channels, may measure a reference signal received quality (RSRQ) parameter (e.g., a PSSCH-RSRQ parameter) associated with various sidelink channels, and/or the like, and may select a channel for transmission of a sidelink communication based at least in part on the measurement(s).

In some cases, the UE 502 may communicate directly with another UE 504 (or with another group of UEs 506, 508; RSU 507) over a sidelink connection (e.g., using a peer-to-peer (P2P) or D2D protocol). Such communications may be referred to as D2D or sidelink communications, where a first UE 502 may be scheduled (e.g., by a base station 102/180 or another UE 104) to transmit data or control information to a second UE 504 over a sidelink. In some cases, a sidelink may be a communication link or a signal transmitted between different UEs 104 in a network, where one UE 104 may act as a relay for information transmitted by another device.

In the example of the wireless communications system 500, one or more of a group of UEs 104 (e.g., UE 502 and UE 504) may support sidelink communications in addition to direct communication with a base station 102 within the coverage area 501 of base station 102. In such cases, the UEs 502 and 504 may be in-coverage. For example, UE 502 may communicate with the base station 102 via communication link 120, while maintaining sidelink communications over sidelink 230-a with the UE 504. In addition, UE 504 may communicate with the base station over communication link 120 while communicating with UE 502 using a sidelink channel. In some in-coverage cases, each UE 104 may be connected to the base station 102 via a direct link (e.g., via a Uu interface).

In the example of wireless communications system 500, one or more of a group of UEs 104 (e.g., UE 508; RSU 507) may support sidelink communication techniques. In the example of FIG. 5, each of the RSU 507 and UE 508 may be outside of the coverage area 501, and may communicate using non-direct links with the base station 102 (e.g., RSU 507, UE 508 may not have an established Uu or RRC connection with base station 102). In other cases, the RSU 507 may be inside the coverage area 501, but may not be able to communicate directly with the bases station 102 (e.g., the RSU 507 may experience interference, reduced signal strength, or otherwise impeded communications). In such cases, the RSU 507 may communicate with the UE 508 using a sidelink channel.

In the example of FIG. 5, the group of UEs 104 may be in partial coverage (e.g., at least one of the UEs may communicate directly with the base station, and at least one other UE may be out of coverage). In such partial-coverage cases, the UE 104 that is in direct communication with the base station (e.g., UE 504) may act as a relay for information transmitted from the base station 102. For example, the UE 504 may receive data or control information directly from the base station 102 via communication link 120, and may relay the information via a sidelink channel to the UE 506. In such cases, the UE 504 may assist communications between the base station 102 and the out of coverage UE 506.

The radio resource allocation for a sidelink communication may be based on resource reservations (e.g., Mode 2). For instance, when a UE is preparing to transmit data on sidelink, the UE may first determine whether resources are reserved by other UEs. Then, the UE may reserve resources from the remaining unreserved resources that are available. The resource allocation for each UE may be in units of one or more subchannels in the frequency domain (e.g., subchannels SC 1 to SC 5), and may be based on one time slot in the time domain. The UE may also use resources in the current slot to perform a first transmission, and may reserve resources in future slots for retransmissions.

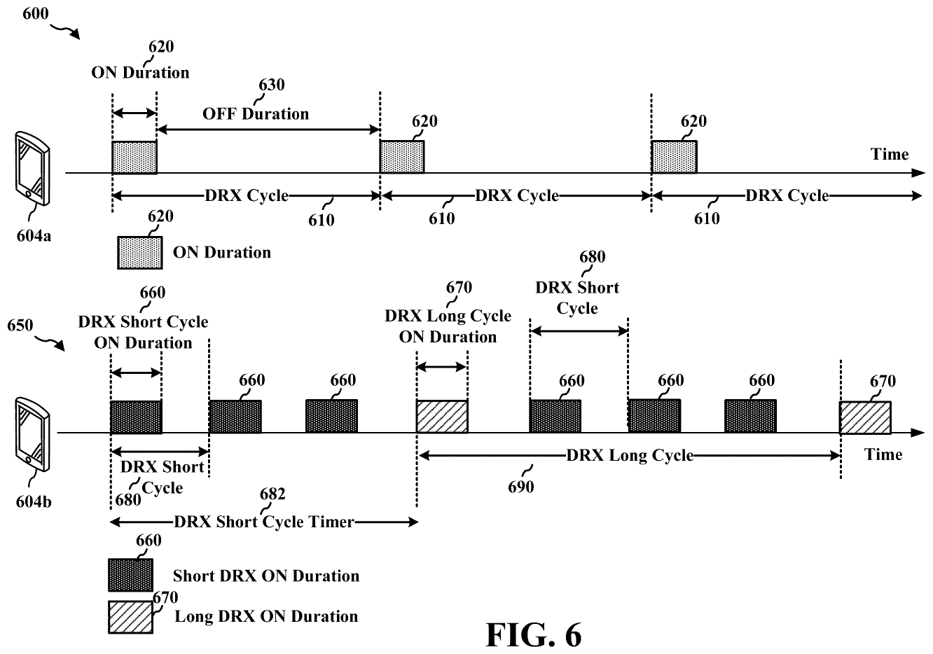

FIG. 6 illustrates example DRX timelines 600, 650. In DRX timeline 600, a UE 604a may be configured by a base station (e.g., 102/180) for DRX. During an RRC connected state, when there is no data transmission in either direction (e.g., UL/DL), the UE 604a may operate using the DRX mode. In the DRX mode, the UE 604a monitors a PDCCH channel discontinuously using a “sleep” and “wake” cycle. When the UE 604a is in an RRC connected state or an RRC connected mode, the DRX may also be referred to as Connected Mode DRX (C-DRX). DRX conserves battery power at the UE 604a. In a non-DRX mode, the UE 604a monitors for PDCCH in each subframe to check whether there is downlink data available. Continuous monitoring of the PDCCH drains a battery power of the UE 604a.

The DRX configuration of the UE 604a may be configured by the network using RRC signaling from the base station 102/180, such as in an RRC Connection Setup request or an RRC connection reconfiguration request. A DRX configuration may include the configuration of one or more timers and values. In some examples, the DRX configuration may include any of an On-Duration Timer, a DRX Inactivity Timer, a DRX Retransmission Timer, a DRX UL Retransmission Timer, a DRX Long Cycle 690, a value of the DRX Start Offset, a DRX Short Cycle Timer 682, and/or a DRX Short Cycle 680, among others. As illustrated in DRX timeline 600, a DRX cycle 610 may comprise a periodic repetition of an on duration in which the UE 604a monitors for PDCCH from the base station 102/180 and an off duration 630.

The DRX cycle 610 may include periodic on durations 620 during which the UE monitors for PDCCH and off durations 630 during which the UE may not monitor for the PDCCH. The off duration 630 may be referred to as a DRX opportunity. During the off duration 630, the UE 604a does not monitor for PDCCH. The UE 604a may enter a sleep mode or a low power mode in which the UE 604a decreases power consumption by shutting down a RF function without detecting communication from another device (e.g., the base station 102/180 at Uu interface, or a sidelink UE 104 at PC5 interface).

The On-duration Timer may correspond to a number of consecutive PDCCH subframes to be monitored or decoded when the UE 604a wakes up from the off duration 630 in the DRX Cycle 610. The DRX Retransmission Timer may correspond to a consecutive number of PDCCH subframes for the UE 604a to monitor when a retransmission is expected by the UE 604a. The DRX Inactivity Timer may correspond to an amount of time before the UE 604a may again enter the off duration 630 following successfully decoding PDCCH. The amount of time may be in terms of a TTI duration. After the UE 604a successfully receives downlink data, the DRX Inactivity Timer may start counting a number of subframes. If any uplink or downlink data transmissions occur while the DRX Inactivity Timer is running, the timer restarts. If the DRX Inactivity Timer expires without uplink or downlink activity, the UE 604a may enter the DRX cycle 610 to achieve power savings.

The example DRX timeline 650 illustrates an example DRX short cycle 680. For example, a UE 604b may start with a DRX short cycle 680. The DRX short cycle 680 may correspond to a first DRX cycle that the UE 604b enters after successful expiration of DRX Inactivity Timer. The DRX short cycle 680 may include periodic on durations 660 during which the UE 604b monitors for PDCCH. The UE 604b may operate using the DRX short cycle 680 until a DRX Short Cycle Timer 682 expires. The DRX Short Cycle Timer 682 may correspond to a number of consecutive subframes during which the UE 604b follows the DRX short cycle 680 after the DRX Inactivity Timer has expired. The example DRX timeline 650 also illustrates an example DRX long cycle 690. For example, once the DRX short cycle 680 expires, the UE 604b may enter a DRX long cycle 690. The DRX long cycle 690 may include periodic on durations 670 during which the UE 604b monitors for PDCCH. In some aspects, the DRX short cycle 680 is used along with the DRX long cycle 690. For example, multiple DRX short cycles 680 can coexist within the DRX long cycle 690. The UE 604b may further be able to transition to an idle DRX mode based on an RRC Inactivity Timer.

Some NR communication systems may support scalable much wider channel BW (CBW) compared to LTE, which relates to data rate, latency, bandwidth, and/or spectrum bands that can be supported. The wide CBW may allow more efficient use of resources than the existing carrier aggregation (CA) schemes. Furthermore, NR provides a mechanism to adjust a UE's operating BW based on the bandwidth part (BWP) concept. With BWP, a UE may not be required to transmit or receive outside of a configured frequency range of an active BWP (except for measurement gaps). The BWP concept allows improvement in power efficiency and/or reduction in power consumption thereby facilitating low power operations.

The concept of BWP for NR may allow operating UEs with smaller BW than the configured CBW, which enables power efficient operations. With the use of BWP, a UE may not be required to transmit or receive outside of the configured frequency range of the active BWP, which allows for and results in power saving. The power saving may be attributed to certain aspects. For example, there may be power savings in some scenarios due to the possibility to operate the RF-baseband interface (e.g., of a UE) with a lower sampling rate and reduced baseband processing needed to transmit or receive with narrower bandwidth. As another example, the bandwidth adaptation may provide UE power savings if the carrier bandwidth prior to bandwidth adaptation is large.

In 5G/NR, a BWP framework may be used to adjust UE receiver bandwidth. The BWP framework may be a useful tool for enabling low power operations. For example, in C-DRX wakeup, a small BWP may be used to monitor control signaling. DCI signaling may be used for BWP switching for data reception, and data scheduling may be delayed (e.g., K0>0, where K0 is a slot offset used for determining the slot allocated for PDSCH scheduled by DCI) for UE switch time. For example, DCI may provide an indication to the IoT device to switch bandwidth part (switch to another bandwidth portion) for data reception.

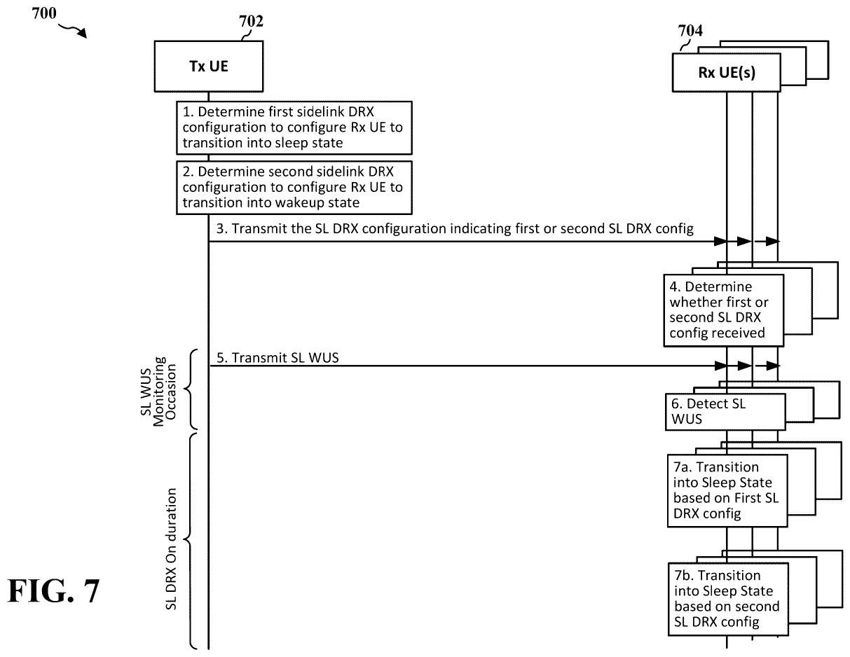

FIG. 7 illustrates an example of a sidelink communication 700 between wireless devices of a C-DRX enhancement with wakeup signal for sidelink communication, in accordance with one or more of aspects of the present disclosure.

In some aspects, a transmitter UE (e.g., 702) can determine a first sidelink DRX configuration to configure a receiver UE (e.g., 704) to transition into a sleep state upon indication of a sidelink WUS (denoted as step “1.”). For example, the first sidelink DRX configuration can configure the receiver UE 704 to transition into a sleep state upon indication of a sidelink WUS.

In other aspects, the transmitter UE 702 can determine a second sidelink DRX configuration to configure the receiver UE 704 to transition into a wakeup state upon indication of the sidelink WUS (denoted as step “2”). For example, the second sidelink DRX configuration configuring the receiver UE 704 to transition into a wakeup state upon indication of the sidelink WUS.

In some aspects, the transmitter UE 702 can transmit, to one or more receiver UEs or a set of receiver UEs (e.g., 704), a sidelink DRX configuration indicating either the first sidelink DRX configuration or the second sidelink DRX configuration (denoted as step “3”). A receiver UE (e.g., 704) can receive the sidelink DRX configuration.

In some aspects, the receiver UE 704 can determine whether the sidelink DRX configuration configures the receiver UE 704 with a first sidelink DRX configuration or a second sidelink DRX configuration (denoted as step “4”).

In some aspects, the transmitter UE 702 can transmit, to the receiver UE 704, the sidelink WUS within a sidelink WUS monitoring occasion in a first DRX cycle based on the sidelink DRX configuration (denoted as step “5”). In turn, the receiver UE 704 can determine whether the sidelink WUS is received within a sidelink WUS monitoring occasion in a first DRX cycle based on the sidelink DRX configuration (denoted as step “6”). In some aspects, the receiver UE 704 may determine that the receiver UE 704 cannot monitor for the sidelink WUS in the first DRX cycle prior to a next sidelink DRX on-duration in the second DRX cycle based on the receiver UE 704 being scheduled to transmit a sidelink communication to a third UE during the sidelink WUS monitoring occasion, in which the receiver UE 704 assumes that the transmitter UE 702 sends the sidelink WUS during the sidelink WUS monitoring occasion. In this regard, the receiver 704 transitions into the wakeup state during the second DRX cycle, and monitors for sidelink data during the next sidelink DRX on-duration to avoid missing the sidelink WUS despite not being able to monitor for the sidelink WUS in the earlier WUS monitoring occasion.

In some implementations, the sidelink WUS is associated with a fixed resource in every N subchannels, where N is a positive integer. In some aspects, the sidelink WUS is received on the fixed resource within the sidelink WUS monitoring occasion based on the sidelink WUS having a first priority greater than a second priority of a reservation for the fixed resource by another transmitter UE. For example, the reservation information can be sent by another transmitter UE via SCI-1. The transmitter UE that determines to send the sidelink WUS can compare the priority of the sidelink WUS with the priority of the reservation information.

In some implementations, the receiver UE 704 may receive, from the transmitter UE 702, within a first sidelink WUS monitoring occasion, the sidelink WUS. In some aspects, the sidelink WUS indicates to the receiver UE 704 to transition into the sleep state or the wakeup state for one or more sidelink DRX on-duration instances following indication of the sidelink WUS. In this regard, the receiver UE 704 may skip monitoring for the sidelink WUS in subsequent occasions by refraining from monitoring for a second sidelink WUS monitoring occasion subsequent to the first sidelink WUS monitoring occasion when a sidelink DRX on-duration corresponding to the second sidelink WUS monitoring occasion is to transition into the sleep state or the wakeup state.

In some implementations, the transmitter UE 702 the receiver UE 704 may receive, from the transmitter UE, within the sidelink WUS monitoring occasion, a SCI that includes the sidelink WUS. In some implementations, the SCI includes a transmission structure that includes the sidelink WUS without data. In other implementations, the SCI includes a transmission structure that includes the sidelink WUS with data. In some aspects, the SCI includes an indication of a destination identifier to indicate which receiver UE (e.g., 704) or set of receiver UEs are to transition into the wakeup state or the sleep state.

In some implementations, the SCI includes a plurality of stages of which a second stage of the plurality of stages carries one or more information blocks in an order based on the destination identifier of each corresponding receiver UE within a group of receiver UEs. In some aspects, each of the one or more information blocks is intended for a specific receiver UE within the group of receiver UEs. In some aspects, at least one of the one or more information blocks indicates the sidelink WUS and further indicates a number of bits corresponding to a number of sidelink DRX on-duration instances for the specific receiver UE to transition into the sleep state or the wakeup state. In some implementations, the number of bits is arranged in a bitmap with each location of the bitmap indicating a different number of sidelink DRX on-duration instances. In other implementations, the number of bits corresponds to a plurality of indices with each index of the plurality of indices indicating a different number of sidelink DRX on-duration instances. In still other implementations, the number of bits is arranged in a start and length indicator value (SLIV) that indicates an index for a starting sidelink DRX on-duration and a number of continuous indices corresponding to sidelink DRX on-duration instances.

In other implementations, the SCI includes a plurality of stages of which a third stage of the plurality of stages carries one or more information blocks in an order based on the destination identifier of each corresponding receiver UE within a group of receiver UEs. In some aspects, each of the one or more information blocks is intended for a specific receiver UE within the group of receiver UEs. In some aspects, a second stage of the plurality of stages includes an indication of whether the third stage of the plurality of stages is being transmitted. In still other implementations, the SCI includes a plurality of stages of which a first stage of the plurality of stages includes an indication of of the sidelink WUS.

In some implementations, the sidelink WUS monitoring occasion is embedded within a sidelink DRX on-duration. In some aspects, the sidelink DRX configuration may configure a first type of sidelink DRX on-duration and a second type of sidelink DRX on-duration different than the first type of sidelink DRX on-duration. For example, the sidelink DRX configuration may configure a short DRX duration and a long DRX duration. In some aspects, the first sidelink DRX configuration is associated with the first type of sidelink DRX on-duration and the second sidelink DRX configuration is associated with the second type of sidelink DRX on-duration different than the first type of sidelink DRX on-duration. In some implementations, the receiver UE 704 transitions into the sleep state based on the first sidelink DRX configuration when the sidelink WUS is received during the first type of sidelink on duration. In other implementations, the receiver UE 704 transitions into the wakeup state based on the second sidelink DRX configuration when the sidelink WUS is received during the second type of sidelink on duration. In some aspects, the sidelink DRX configuration indicates which of the first type of sidelink DRX on-duration or the second type of sidelink DRX on-duration is configured to support mini-slot transmission. In some aspects, the receiver UE 704 may monitor for the SCI during one or more mini slots of the sidelink WUS monitoring occasion in the first type of sidelink DRX on-duration or the second type of sidelink DRX on-duration. For example, the receiver 704 may monitor for the SCI that may indicate the sidelink WUS during one or more mini slots within a short DRX on-duration or a long DRX on-duration.

In other implementations, the sidelink WUS monitoring occasion is outside of a sidelink DRX on-duration within a DRX cycle. In some aspects, the sidelink DRX configuration can configure a location of the sidelink WUS monitoring occasion by an offset between a start of a sidelink WUS monitoring window and a duration spanning the sidelink WUS monitoring window. In some aspects, an end of the sidelink WUS monitoring window and a start of a sidelink DRX on-duration are separated by a minimum gap based on the offset and the duration. In some aspects, the sidelink WUS monitoring window includes a plurality of candidate sidelink WUS monitoring occasions, in which the duration includes a plurality of mini slots. In some aspects, each candidate sidelink WUS monitoring occasion of the plurality of candidate sidelink WUS monitoring occasions corresponds to one mini slot of the plurality of mini slots.

In some implementations, the receiver UE 704 may receive a physical sidelink feedback channel (PSFCH) that includes the sidelink WUS within the sidelink WUS monitoring occasion. The sidelink WUS monitoring occasion may be embedded within a sidelink DRX on-duration in some implementations, or may be located outside of the sidelink DRX on-duration in other implementations. In some aspects, a location of the sidelink WUS monitoring occasion is configured by a first PSFCH resource pool that is separate from a second PSFCH resource pool for conflict indication and feedback signaling.

In some aspects, the first PSFCH resource pool and the second PSFCH resource pool include PSFCH resources with separate physical resource blocks (PRBs), in which the sidelink WUS monitoring occasion and the conflict indication and feedback signaling are allocated to the PSFCH in a same time slot using different PRBs. In other aspects, the first PSFCH resource pool and the second PSFCH resource pool include PSFCH resources with multiple time slots, in which the sidelink WUS monitoring occasion is allocated to a first PSFCH and the conflict indication and the feedback signaling are allocated to a second PSFCH in different time slots using a different number of PRBs. In some aspects, the first PSFCH has a first periodicity that is greater than a second periodicity of the second PSFCH.

In other aspects, a location of the sidelink WUS monitoring occasion is configured by a PFSCH resource pool that is common with feedback signaling, in which the sidelink WUS monitoring occasion and the feedback signaling are allocated to same PRBs using different cyclic shift pairs.

In some implementations, the PSFCH includes a plurality of sets of PRBs that is split by a number of sidelink DRX on-duration instances of which an order of each set of PRBs of the plurality of sets PRBs is aligned with a corresponding sidelink DRX on-duration instance in time. In some aspects, each set of PRBs of the plurality of sets PRBs includes one or more PRBs mapped with an indication of the sidelink WUS based on a destination identifier corresponding to the receiver UE 704. In some aspects, the sidelink DRX configuration indicates that the sidelink WUS monitoring occasion is located in a PSFCH occasion that is nearest in position to a next sidelink DRX on-duration than other PSFCH occasions. In other aspects, the sidelink DRX configuration indicates that the sidelink WUS monitoring occasion is located in a first PSFCH occasion that is nearest in position to the next sidelink DRX on-duration than a second PSFCH occasion or is located in the second PSFCH occasion that is second nearest in position to the next sidelink DRX on-duration. In some aspects, the receiver UE 704 can monitor for the PSFCH in the second PSFCH occasion and monitor for the PSFCH in the first PSFCH occasion when the PSFCH is not detected in the second PSFCH occasion.

In some aspects, the receiver UE 704 can transition into the sleep state in a second DRX cycle based on the sidelink WUS being received within the sidelink WUS monitoring occasion and the sidelink DRX configuration configuring the receiver UE 704 with the first sidelink DRX configuration (denoted as step “7a”). In other aspects, the receiver UE 704 may refrain from transitioning into the sleep state during the second DRX cycle if the sidelink WUS is not being received within the sidelink WUS monitoring occasion. In this regard, the receiver UE 704 may instead monitor for sidelink data during a sidelink DRX on-duration in the second DRX cycle. In some aspects, the receiver UE 704 may skips being in an active state during a first sidelink DRX on-duration in the second DRX cycle when the receiver UE 704 transitions into the sleep state and remains in the sleep state until a second sidelink DRX on-duration in a third DRX cycle.

In other aspects, the receiver UE 704 can transition into the wakeup state in the second DRX cycle based on the sidelink WUS being received within the sidelink WUS monitoring occasion and the sidelink DRX configuration configuring the receiver UE 704 with the second sidelink DRX configuration (denoted as step “7b”). In other aspects, the receiver UE 704 may refrain from transitioning into the wakeup state during the second DRX cycle based on the sidelink WUS not being received within the sidelink WUS monitoring occasion.

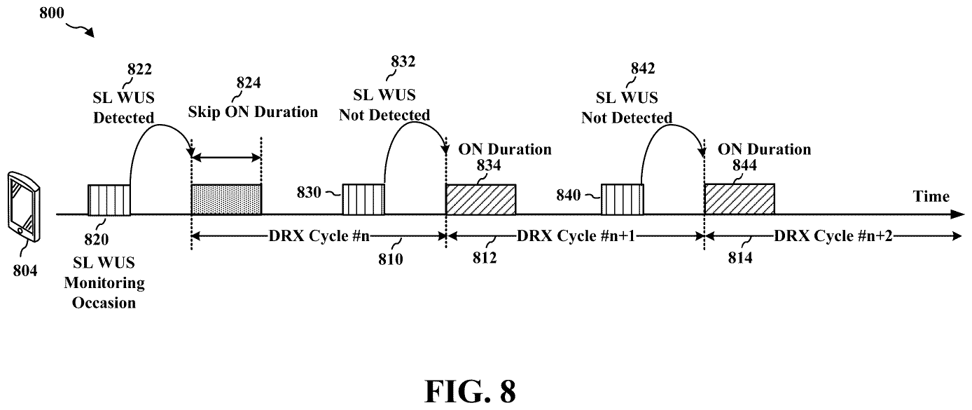

FIG. 8 is a diagram illustrating an example of DRX cycles with WUS monitoring occasions along timeline 800, in accordance with one or more of aspects of the present disclosure. In some implementations, a transmitter UE (not shown) can indicate whether a receiver UE (e.g., 804) should stay active to receive new data or skip a current sidelink DRX on-duration until a next sidelink DRX on-duration. This indication sent by the transmitter UE is a sidelink wake-up signal.

In some implementations, the transmitter UE can define the interpretation of the sidelink WUS via PC-5 RRC signaling. For example, the transmitter UE can transmit a sidelink DRX configuration. In the sidelink DRX configuration, if the field exists, the receiver UE does not go-to-sleep if the sidelink WUS is not detected outside of the DRX active time (also referred to as the sidelink DRX on-duration). Alternatively, the receiver UE transitions into a sleep state (or skips the current sidelink DRX on-duration) upon the indication of the sidelink WUS. For example, the receiver UE 804 may be configured with a first sidelink DRX configuration that configures the receiver UE 804 to transition into a sleep state upon detecting the sidelink WUS. The receiver UE 804 may monitor for the sidelink WUS during a sidelink WUS monitoring occasion 820, and detects the sidelink WUS (e.g., 822) during the sidelink WUS monitoring occasion 820. In this regard, the receiver 804 transitions into the sleep state within DRX cycle 810 (e.g., #n) and skips a sidelink DRX on-duration 824 within the DRX cycle 810. Within the DRX cycle 810, the receiver 804 may again monitor for the sidelink WUS during a sidelink WUS monitoring occasion 830 that is located outside of the sidelink DRX on-duration 824 and a sidelink DRX on-duration 834 associated with a subsequent DRX cycle (e.g., 812). The receiver UE 804 may not detect the sidelink WUS (e.g., 832) during the sidelink WUS monitoring occasion 830 such that the receiver UE 804 remains active and refrains from transitioning into the sleep state within the DRX cycle 812. Within the DRX cycle 812, the receiver 804 may again monitor for the sidelink WUS during a sidelink WUS monitoring occasion 840 that is located outside of the sidelink DRX on-duration 834 and a sidelink DRX on-duration 844 associated with a subsequent DRX cycle (e.g., 814). The receiver UE 804 may not detect the sidelink WUS (e.g., 842) during the sidelink WUS monitoring occasion 840 such that the receiver UE 804 remains active and refrains from transitioning into the sleep state within the DRX cycle 814.

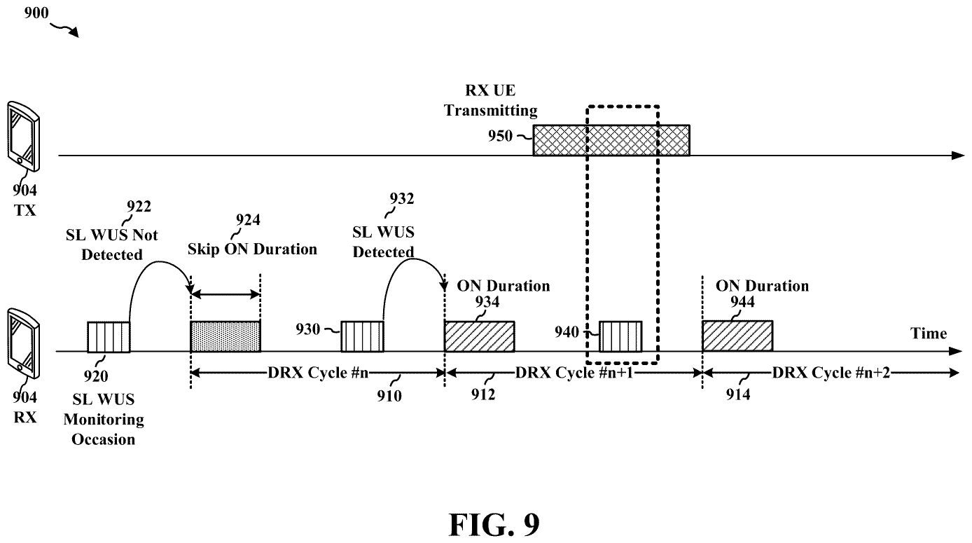

FIG. 9 is a diagram illustrating another example of DRX cycles with WUS monitoring occasions along timeline 900, in accordance with one or more of aspects of the present disclosure. In some implementations, a transmitter UE (not shown) can indicate whether a receiver UE (e.g., 904) should stay in a sleep state or transition into a wakeup state to receive new data in a next sidelink DRX on-duration. This indication sent by the transmitter UE is a sidelink wake-up signal.

In the sidelink DRX configuration, if the field is absent, the receiver UE does not wake-up if the sidelink WUS is not detected outside of the DRX active time. In this regard, the receiver UE would only wake up for a given DRX on-duration upon the indication of the sidelink WUS. For example, the receiver UE 904 may be configured with a second sidelink DRX configuration that configures the receiver UE 904 to transition into a wakeup state upon detecting the sidelink WUS. The receiver UE 904 may monitor for the sidelink WUS during a sidelink WUS monitoring occasion 920, and does not detect the sidelink WUS (e.g., 922) during the sidelink WUS monitoring occasion 920. In this regard, the receiver 904 refrains from transitioning into the wakeup state within DRX cycle 910 (e.g., #n) and skips being active in sidelink DRX on-duration 924 within the DRX cycle 910. Within the DRX cycle 910, the receiver 904 may again monitor for the sidelink WUS during a sidelink WUS monitoring occasion 930 that is located outside of the sidelink DRX on-duration 924 and a sidelink DRX on-duration 934 associated with a subsequent DRX cycle (e.g., 912). The receiver UE 904 detects the sidelink WUS (e.g., 932) during the sidelink WUS monitoring occasion 930 such that the receiver UE 904 transitions into the wakeup state so that it is active to receive new data during the sidelink DRX on-duration 934. Within the DRX cycle 912, the receiver 904 may again monitor for the sidelink WUS during a sidelink WUS monitoring occasion 940 that is located outside of the sidelink DRX on-duration 934 and a sidelink DRX on-duration 944 associated with a subsequent DRX cycle (e.g., 914). However, in this case, the receiver UE 904 cannot monitor for the sidelink WUS before the next sidelink DRX on-duration 944 because the receiver UE 904 may be transmitting to another UE during the sidelink WUS monitoring occasion 940 (denoted by the dashed vertical rectangle) due to a half duplex restriction. Because the receiver UE 904 may not monitor for the sidelink WUS, the receiver UE 904 may remain active by refraining from transitioning into the sleep state within the DRX cycle 914 to receive new data during the sidelink DRX on-duration 944 as the receiver UE may assume that the transmitter UE sent the sidelink WUS during the sidelink WUS monitoring occasion 940.

Since a listen-before-talk (LBT) procedure is needed before a transmitter UE can send a sidelink WUS, the receiver UE may not transition into a wakeup state if the LBT procedure fails for C-DRX enhancement with WUS based on the second sidelink DRX configuration. However, for C-DRX enhancement with WUS based on the first sidelink DRX configuration, the receiver UE can transition into the wakeup state even if the LBT procedure fails before the transmitter UE can send the sidelink WUS.

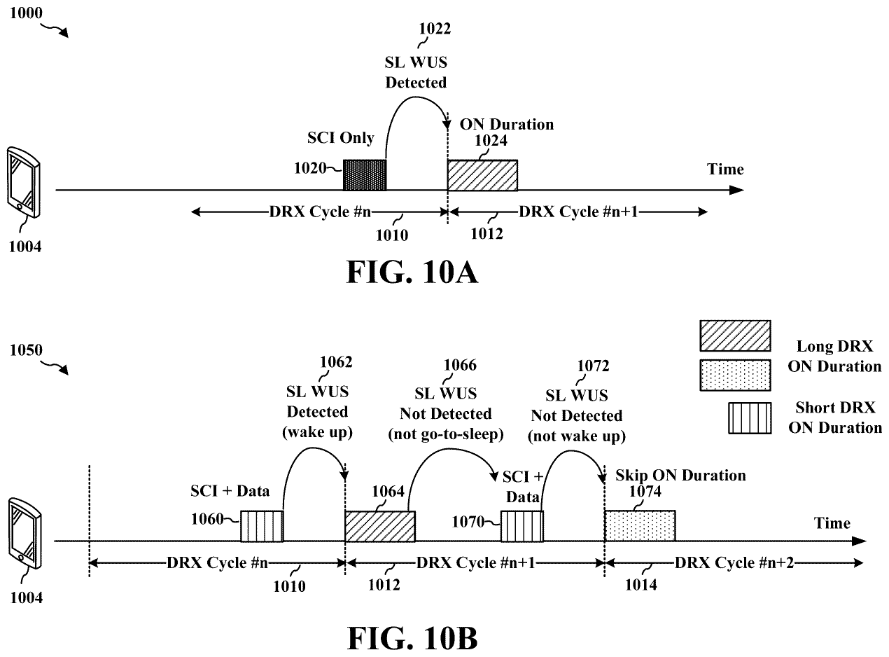

FIG. 10A is a diagram illustrating an example of DRX cycles with SCI transmitted in WUS monitoring occasions along timeline 1000, in accordance with one or more of aspects of the present disclosure. In some implementations, a sidelink WUS can transmitted in the SCI. In some aspects, the transmission structure of the sidelink WUS may include the sidelink WUS being carried in the SCI and transmitted in sidelink WUS monitoring occasions with a SCI-only structure (e.g., excludes a data payload). For example, a receiver UE 1004 may monitor for the sidelink WUS during a sidelink WUS monitoring occasion 1020 that includes the SCI-only structure. The receiver UE 1004 may detect the sidelink WUS during the sidelink WUS monitoring occasion 1020 within DRX cycle 1010. In turn, the receiver UE 1004 may transition into a sleep state within DRX cycle 1012 and skip being active during a sidelink DRX on-duration 1024 if the receiver UE 1004 is configured with the first sidelink DRX configuration, or the receiver UE 1004 may transition into a wakeup state within the DRX cycle 1012 and remain active during the sidelink DRX on-duration 1024 if the receiver 1004 is configured with the second sidelink DRX configuration.

FIG. 10B is a diagram illustrating another example of DRX cycles with SCI transmitted in WUS monitoring occasions embedded in DRX on-duration instances along timeline 1050, in accordance with one or more of aspects of the present disclosure. In some implementations, the sidelink WUS is carried in SCI and transmitted with data. The sidelink WUS monitoring occasions may be embedded in a prior sidelink DRX on-duration. In this case, more than one DRX configuration can be configured to a receiver UE with different parameters (e.g., different on duration, different starting point, different DRX cycle). In some aspects, the configuration of the sidelink WUS transmitted in different DRX on-duration instances can be different. For example, there may be two types of sidelink DRX on-duration instances. For example, a first type of sidelink DRX on-duration may be referred to as a short DRX on-duration, in which a sidelink WUS transmitted in this DRX on-duration can refer to a configuration of the receiver UE to transition into a wakeup state. In another example, a second type of sidelink DRX on-duration may be referred to as a long DRX on-duration, in which a sidelink WUS transmitted in this DRX on-duration can refer to a configuration of the receiver UE to transition into a sleep state. In some aspects, if the transmitter UE fails to transmit a sidelink WUS in the long DRX on-duration, then the transmitter UE can still utilize a sidelink WUS transmission in a next short DRX on-duration to control whether the receiver UE should wake-up in the next long DRX on-duration.

In some aspects, the transmission structure of the sidelink WUS may include the sidelink WUS being carried in the SCI and transmitted in sidelink WUS monitoring occasions with a SCI-and-data structure (e.g., includes a data payload). In this regard, the SCI may be embedded within certain types of sidelink DRX on-duration instances (e.g., short DRX on-duration). For example, a receiver UE 1004 may monitor for the sidelink WUS during a sidelink WUS monitoring occasion 1060, which is embedded within a short DRX on-duration and includes the SCI-and-data structure. The receiver UE 1004 may detect the sidelink WUS during the sidelink WUS monitoring occasion 1060 within DRX cycle 1010. Because the sidelink WUS is detected within the short DRX on-duration, the receiver UE 1004 may transition into a wakeup state within DRX cycle 1012 and skip being active during a sidelink DRX on-duration 1024. Within the DRX cycle 1012, the receiver 1004 may again monitor for the sidelink WUS during a sidelink WUS monitoring occasion 1064, which is embedded within a long DRX on duration. The receiver UE 1004 may not detect the sidelink WUS (e.g., 1066) during the sidelink WUS monitoring occasion 1064. Because the sidelink WUS is not detected within a long DRX on-duration, the receiver UE 1004 refrains from transitioning into the sleep state within the DRX cycle 1012 and remains active during the long DRX on duration (e.g., 1064). Within the DRX cycle 1012, the receiver 1004 may again monitor for the sidelink WUS during a sidelink WUS monitoring occasion 1070, which is embedded within a short DRX on-duration. The receiver UE 1004 may not detect the sidelink WUS (e.g., 1072) during the sidelink WUS monitoring occasion 1070. Because the sidelink WUS is not detected within the short DRX on-duration (e.g., 1070), the receiver UE 1004 refrains from transitioning into the wakeup state within the DRX cycle 1014 and skips being active during the long DRX on-duration 1074 within DRX cycle 1014. For illustrative purposes and not limiting in scope of the present disclosure, the receiver UE 1004 may transition into the sleep state within the DRX cycle 1012 prior to the sidelink DRX on-duration 1074.

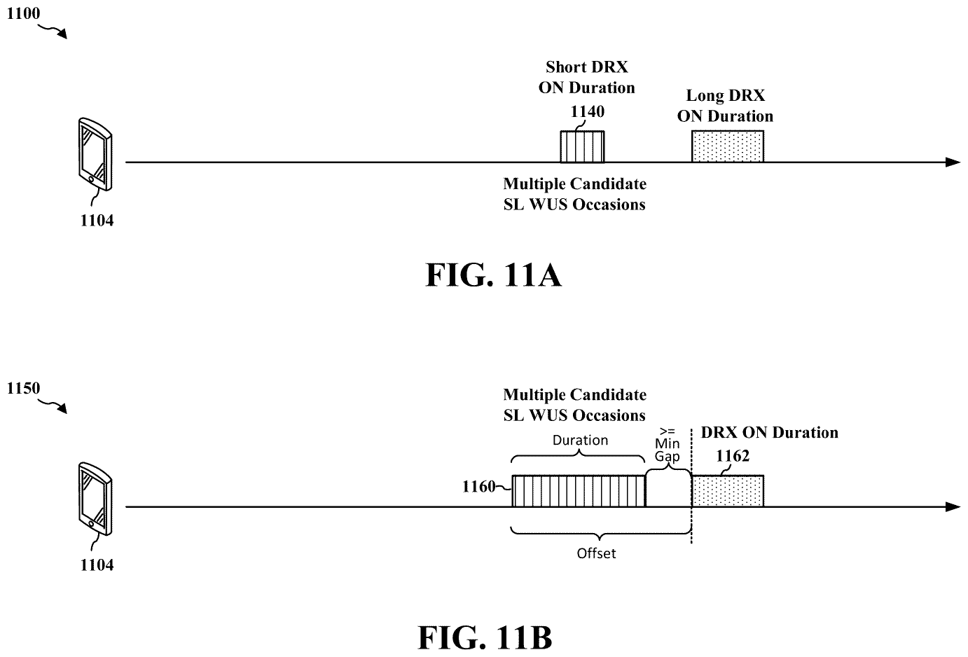

FIG. 11A is a diagram illustrating an example of sidelink WUS monitoring occasions embedded in a DRX on duration, in accordance with one or more of aspects of the present disclosure. In some implementations, the sidelink WUS may be transmitted at a location that is embedded in a previous DRX on-duration to save power. For a sidelink WUS monitoring occasion embedded in the previous DRX on-duration, a transmitter UE can indicate which type of DRX on-duration (e.g., short DRX on-duration, long DRX on-duration) is configured to perform mini-slot transmission. For example, the transmitter UE may indicate that the short DRX on-duration is performing the mini-slot transmission, and therefore, the receiver UE may perform mini-slot SCI monitoring. As illustrated in FIG. 11A, a receiver UE 1104 may monitor for a sidelink WUS during multiple candidate sidelink WUS monitoring occasions embedded within a short DRX on-duration 1140. For example, the receiver UE 1104 may monitor for the sidelink WUS within different mini-slots in the short DRX on-duration 1140.

FIG. 11B is a diagram illustrating an example of sidelink WUS monitoring occasions outside of a DRX on duration, in accordance with one or more of aspects of the present disclosure. In some implementations, the sidelink WUS may be transmitted at a location that is outside of a sidelink DRX on-duration. For a sidelink WUS monitoring occasion that is outside of a sidelink DRX on-duration, the location of the sidelink WUS may be configured by an offset parameter and a duration parameter via PC-5 RRC configuration, where a transmitter UE determines the sidelink WUS monitoring occasion for its receiver UE. In some aspects, the offset parameter may indicate an offset of time between a starting point of a candidate sidelink WUS monitoring occasion and a starting point of a next sidelink DRX on-duration. In some aspects, the duration parameter may indicate a duration of time from the starting point of a first candidate sidelink WUS monitoring occasion and an ending point of a last candidate sidelink WUS monitoring occasion. The offset and duration parameters may be configured with values to achieve a minimum gap between the ending point of the last candidate sidelink WUS monitoring occasion and the starting point of the next sidelink DRX on-duration. As illustrated in FIG. 11B, a receiver UE 1104 may monitor for a sidelink WUS during a sidelink WUS monitoring window 1160 containing multiple candidate sidelink WUS monitoring occasions located outside of a sidelink DRX on-duration 1162. In some implementations, mini-slot transmission can be used for a sidelink WUS monitoring occasion outside of the sidelink DRX on-duration to provide multiple monitoring occasions in a given duration to compensate for any LBT uncertainty. For example, each of the occasions within the sidelink WUS monitoring window 1160 may correspond to one mini-slot.

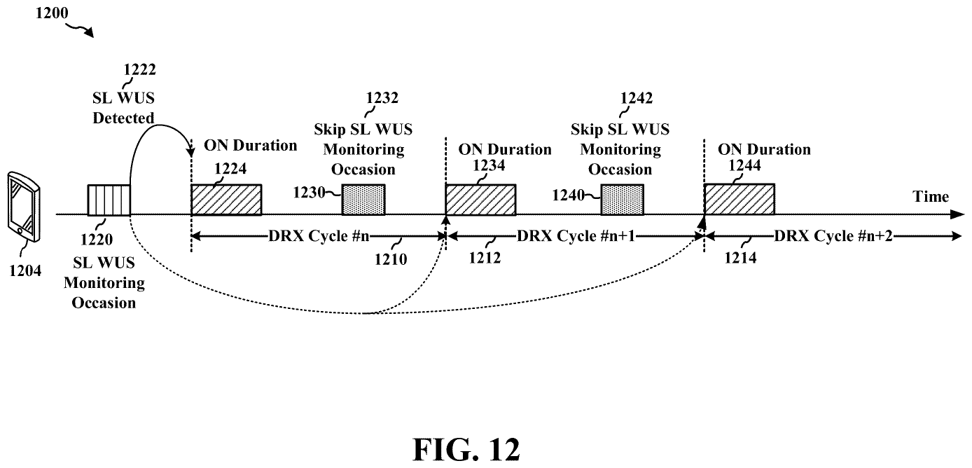

FIG. 12 is a diagram illustrating an example of DRX cycles with a sidelink WUS associated with multiple successive DRX on duration instances, in accordance with one or more of aspects of the present disclosure. In some implementations, one sidelink WUS can indicate whether the receiver UE is to wake-up or go-to-sleep in a next sidelink DRX on-duration as well as one or more subsequent sidelink DRX on-duration instances. If so, the receiver UE can skip a sidelink WUS monitoring occasion if the corresponding sidelink DRX on-duration is already to transition into the wakeup state or into the sleep state.

As illustrated in FIG. 12, a receiver UE 1204 may monitor for the sidelink WUS during a sidelink WUS monitoring occasion 1220, and detects the sidelink WUS (e.g., 1222) during the sidelink WUS monitoring occasion 1220. In this regard, the receiver 1204 transitions into a sleep state within DRX cycle 1210 (e.g., #n) and skips a sidelink DRX on-duration 1224 within the DRX cycle 1210 if the receiver UE 1204 is configured with the first sidelink DRX configuration, or the receiver 1204 transitions into a wakeup state within the DRX cycle 1210 if the receiver UE 1204 is configured with the second sidelink DRX configuration. Because the sidelink WUS 1222 that is detected within the sidelink WUS monitoring occasion 1220 also indicates that subsequent sidelink DRX on-duration instances (e.g., 1234, 1244) are also configured with the same DRX state transition, the receiver UE 1204 can skip monitoring for the sidelink WUS (e.g., 1232, 1242) during the sidelink WUS monitoring occasions 1230, 1240, respectively.

In unlicensed sidelink communication, one UE may communicate with multiple UEs. In order to avoid overlapping the sidelink WUS occasion with DRX on-duration instances of other UEs, the configuration of the sidelink WUS occasion can be different for different DRX on-duration instances (e.g., the sidelink WUS monitoring occasion can be separately configured for each of the DRX on-duration instances). In some implementations, a transmitter UE can use a destination identifier (ID) to indicate which receiver UE or which set of receiver UEs need(s) to transition into the wakeup state or into the sleep state.

In some aspects, the SCI may include a SCI-2 format, where the SCI-2 carries one or more information blocks, with each information block intended for a specific receiver UE. In some aspects, the information block may contain a 1-bit sidelink WUS indication and N bits to indicate that X subsequent DRX on-duration(s) are also for the receiver UE to transition into the wakeup state or into the sleep state. In some aspects, the order of the information blocks may be determined by the receiver UE identifier within the group. In one example, when X=N, the N bits can be formed as a bitmap to indicate the following N sidelink DRX on-duration(s). In another example, when X=2^{N}, for N=2, the index=00 may correspond to the one subsequent DRX on-duration, the index=01 may correspond to two subsequent DRX on-durations, and so on. In other aspects, N bits can be formed as a SLIV to indicate the starting DRX on-duration index and a number of continuous indices. In some implementations, the SCI may include a third stage, where SCI-3 carries one or more information blocks, with each information block intended for a specific receiver UE. In some aspects, if the sidelink WUS indication signal is enabled in SCI-2, the SCI-3 can be transmitted by the transmitter UE. Otherwise, the transmitter UE does not transmit the SCI-3. In other implementations, the sidelink WUS is carried in SCI-1 with a 1-bit sidelink WUS indication.

To reduce the blind detection complexity, the sidelink WUS can be fixed in every N subchannels. If a subchannel to be used by the transmitter UE for transmission of the sidelink WUS is reserved by another UE, the sidelink WUS may not be transmitted by the transmitter UE in some implementations, or the transmitter UE can compare a priority of the sidelink WUS with a priority of the reserved resource to decide whether the sidelink WUS can be transmitted in other implementations.

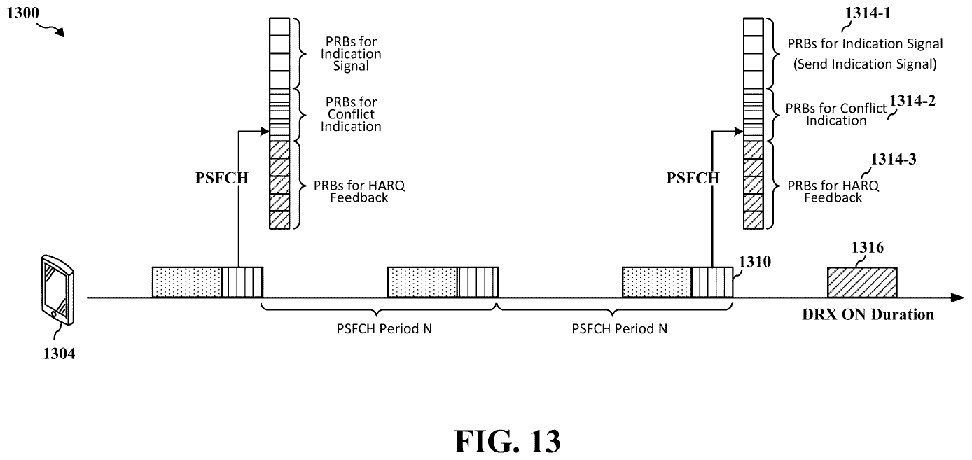

FIG. 13 is a diagram illustrating an example of DRX cycles with PSFCH transmitted in WUS monitoring occasions along timeline 1300, in accordance with one or more of aspects of the present disclosure. In some implementations, a sidelink WUS is carried in PSFCH. Since PSFCH can only carry 1 bit of information, the sidelink WUS may be a 1-bit sidelink WUS indication.

In some implementations, the location of the sidelink WUS is configured by a separate PSFCH resource pool. For example, the PSFCH may be allocated with separate PRBs between the resource pools. In some aspects, the sidelink WUS may be included in one PSFCH time instance. For example, PSFCH resources may be allocated in different PRBs for the sidelink WUS, conflict indication and HARQ feedback. As illustrated in FIG. 13, a receiver UE 1304 may monitor for the sidelink WUS in a sidelink WUS monitoring occasion within a PSFCH 1310. In some aspects, the PFSCH occasions have a period N, where N is a positive integer. The PSFCH 1310 may include a first set of PRBs 1314-1 is allocated for the sidelink WUS indication signal, a second set of PRBs 1314-2 is allocated for the conflict indication, and a third set of PRBs 1314-3 is allocated for the HARQ feedback. In some implementations, the PSFCH occasion at the position along the timeline 1300 that is nearest in time and before a next DRX on-duration (e.g., DRX on-duration 1316) can be configured to be detected by a receiver UE for transitioning between DRX states (e.g., sleep, wakeup). For example, the receiver UE 1304 may attempt to receive the PSFCH 1310 with the sidelink WUS indication signal in a PSFCH occasion that is nearest in time to the DRX on-duration 1316.

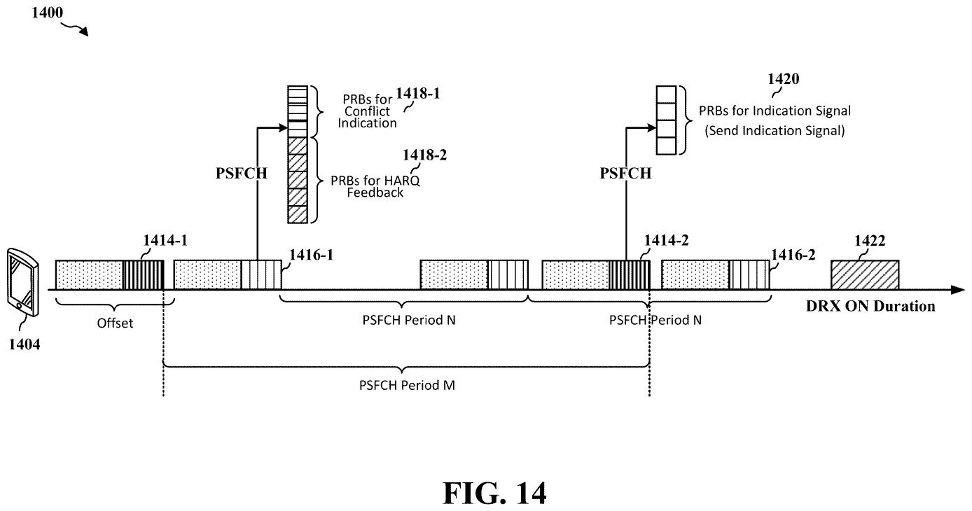

FIG. 14 is a diagram illustrating another example of DRX cycles with PSFCH transmitted in WUS monitoring occasions along timeline 1400, in accordance with one or more of aspects of the present disclosure. In some implementations, a sidelink WUS is carried in PSFCH. In some implementations, the location of the sidelink WUS is configured by a separate PSFCH resource pool. In some aspects, two PSFCH time instances may be used, where one PSFCH time instance is used for exclusively transmitting the sidelink WUS. For example, the PSFCH 1416-1 may include a first set of PRBs 1418-1 allocated for the conflict indication and a second set of PRBs 1418-2 allocated for the HARQ feedback. PSFCH 1414-2 may include PRBs 1420 exclusively allocated for the sidelink WUS indication signal. In some aspects, the PSFCH containing the sidelink WUS (e.g., PSFCH 1414-2) may be transmitted at a different slot than a PSFCH containing the HARQ feedback and conflict indication (e.g., PSFCH 1416-1). In this case, the PSFCH 1414-2 for carrying indication of the sidelink WUS can have a larger periodicity than the PSFCH 1416-1. For example, each of PSFCH 1414-1 and 1414-2 has a period M and each of PSFCH 1416-1 and 1416-2 has a period N, where M is greater than N. In this case, more PRBs can be used for carrying the HARQ-ACK feedback and conflict indication to reduce the likelihood of a collision. The number of PRBs in a resource pool for PSFCH transmission containing the sidelink WUS indication signal can be pre-configured or configured by RRC signaling.

In some implementations, the PSFCH occasion at the position along the timeline 1400 that is nearest in time and before a next DRX on-duration (e.g., DRX on-duration 1422) can be configured to be detected by the receiver UE 1404 for transitioning between DRX states (e.g., sleep, wakeup). For example, the receiver UE 1404 may attempt to receive the PSFCH 1414-2 with the sidelink WUS indication signal in a PSFCH occasion that is nearest in time to the DRX on-duration 1422. In other implementations, the PSFCH occasion at the position along the timeline 1400 that is second nearest in time and before the next DRX on-duration 1422 can be configured to be detected by the receiver UE 1404 for transitioning between DRX states. For example, the receiver UE 1404 may attempt to receive the PSFCH 1414-1 with a sidelink WUS indication signal in a PSFCH occasion that is second nearest in time to the DRX on-duration 1422. In some aspects, such configuration of the PSFCH can be done via PC-5 RRC signaling.

In some aspects, the receiver UE 1404 may first attempt to detect the sidelink WUS in the PSFCH 1414-1 at the second most recent position before the DRX on-duration 1422. If the PSFCH 1414-1 is not detected by the receiver UE 1404 to contain the sidelink WUS, the receiver UE 1404 can attempt to detect the sidelink WUS in the PSFCH 1414-2 at the first most recent position before the DRX on-duration 1422.

In some aspects, the location of the sidelink WUS may be configured by a common PSFCH resource pool with different cyclic shift pairs. In some aspects, the PSFCH resources for the sidelink WUS can be allocated in the same PRBs as the HARQ-ACK feedback. As such, the HARQ-ACK feedback and the sidelink WUS can be configured with different cyclic shift pairs.

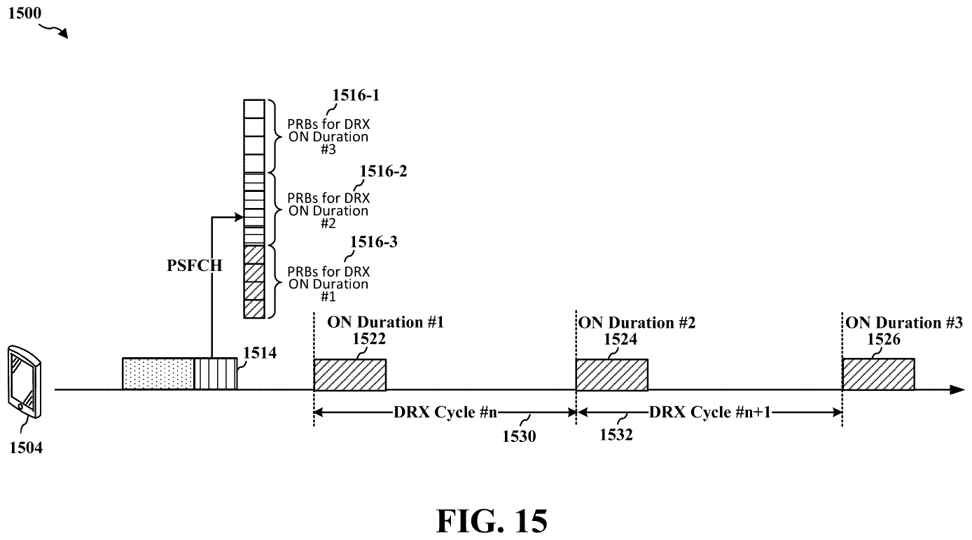

FIG. 15 is a diagram illustrating still another example of DRX cycles with PSFCH transmitted in WUS monitoring occasions along timeline 1500, in accordance with one or more of aspects of the present disclosure. In some implementations, the PRBs in a PSFCH is split by a number of DRX on-duration instances that correspond to one PSFCH time slot (or one PSFCH occasion). For example, the sidelink WUS indication signal to PSFCH mapping may be at least based on a destination ID corresponding to a receiver UE (e.g., 1504). This may be expressed as (destination ID) mod

$${N}_{Indication Signal}^{PSFCH} ,$$

where

$${N}_{Indication Signal}^{PSFCH}$$

consists of the number of PRBs corresponding to one DRX on-duration instance and the number of cyclic shift pairs. In some aspects, if a transmitter UE intends to configure multiple UEs to transition into the wakeup state or into the sleep state, the transmitter UE can transmit multiple PSFCHs simultaneously. The maximum number of PSFCHs that can be transmitted may be determined based on the UE capability of the receiver UEs. For example, a receiver UE 1504 may monitor for a sidelink WUS in a PSFCH 1514 that includes a first set of PRBs 1516-1 for a first DRX on-duration 1522 (denoted as #1), a second set of PRBs 1516-2 for a second DRX on-duration 1524 (denoted as #2), and a third set of PRBs 1516-3 for a third DRX on-duration 1526 (denoted as #3). In this regard, if the sidelink WUS is detected within the first set of PRBs 1516-1, then the receiver UE 504 may transition DRX states during the first DRX on-duration 1522. Similarly, if the sidelink WUS is detected within the second set of PRBs 1516-2, then the receiver UE 504 may transition DRX states during the second DRX on-duration 1524. Further, if the sidelink WUS is detected within the third set of PRBs 1516-3, then the receiver UE 504 may transition DRX states during the third DRX on-duration 1526.

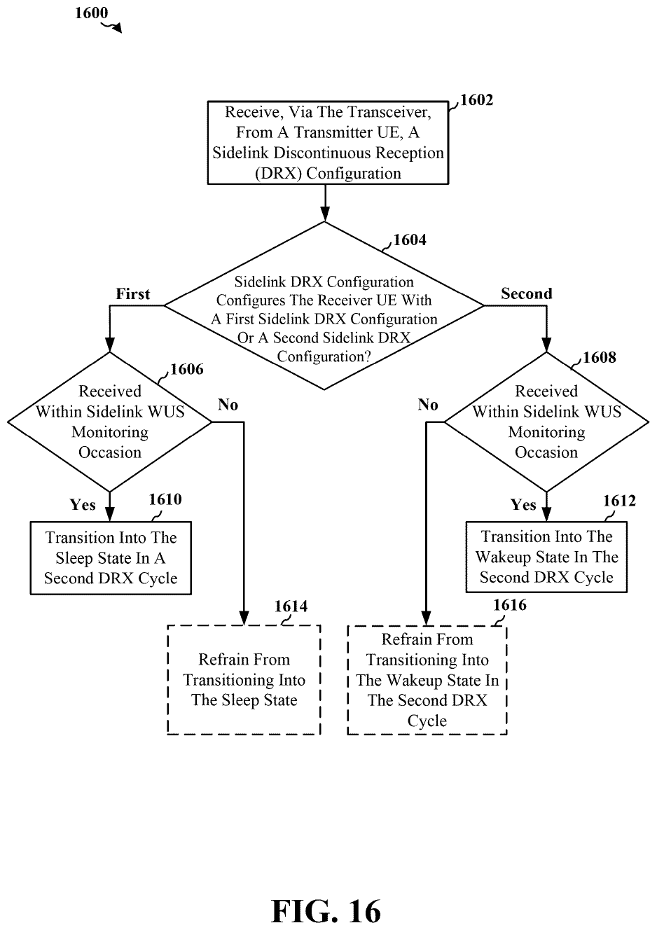

FIG. 16 is a flowchart 1600 illustrating a process of wireless communication that supports C-DRX enhancement with wakeup signal for sidelink communication at a receiver UE in accordance with some aspects of the present disclosure. As illustrated, the flowchart 1600 includes a number of enumerated steps, but embodiments of the flowchart 1600 may include additional steps before, after, and in between the enumerated steps. In some embodiments, one or more of the enumerated steps may be omitted or performed in a different order. Optional aspects are illustrated with a dashed line.

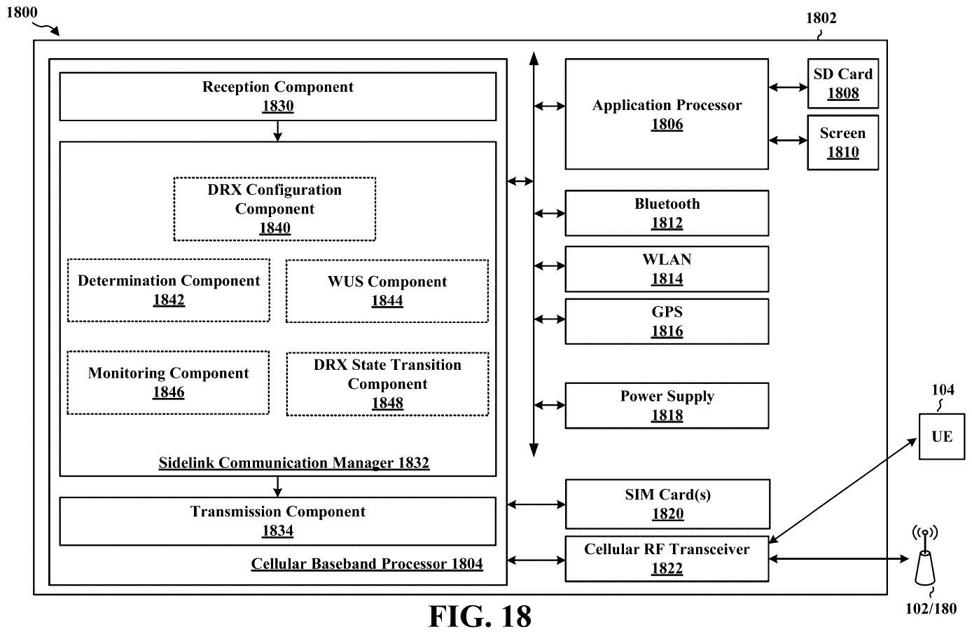

At 1602, the UE receives, from a transmitter, a sidelink DRX configuration. In the context of FIGS. 1 and 5-15, for example, the UE 104/704 may receive the sidelink DRX configuration. For instance, 1602 may be performed by one or more components described with respect to FIG. 4, e.g., controller/processor 459, receive processor 456, receiver/transmitter 454 and/or antenna 452. The sidelink DRX configuration may be received, e.g., by the DRX configuration component 1840 via the reception component 1830 of the apparatus 1802 in FIG. 18.

At 1604, the UE determines whether the sidelink DRX configuration configures the receiver UE with a first sidelink DRX configuration or a second sidelink DRX configuration. In the context of FIGS. 1 and 5-15, for example, the UE 104/704 may perform the determination between the first and second sidelink DRX configurations. For instance, 1604 may be performed by one or more components described with respect to FIG. 4, e.g., controller/processor 459. The determination of whether the sidelink DRX configuration configures the receiver UE with a first sidelink DRX configuration or a second sidelink DRX configuration may be performed, e.g., by the determination component 1842 through coordination with the DRX configuration component 1840 of the apparatus 1802 in FIG. 18. If the UE 104 determines that the sidelink DRX configuration configures the UE with the first sidelink DRX configuration, then the process proceeds to block 1606, otherwise the process proceeds to block 1608.

At 1606, the UE determines whether the sidelink WUS is received within a sidelink WUS monitoring occasion in a first DRX cycle based on the first sidelink DRX configuration. In the context of FIGS. 1 and 5-15, for example, the UE 104/704 may perform the determination of the arrival time of the sidelink WUS. For instance, 1604 may be performed by one or more components described with respect to FIG. 4, e.g., controller/processor 459. The determination of whether the sidelink WUS is received within the sidelink WUS monitoring occasion may be performed, e.g., by the determination component 1842 through coordination with the monitoring component 1846 of the apparatus 1802 in FIG. 18. If the sidelink WUS is received within the sidelink WUS monitoring occasion, then the process proceeds to block 1610, otherwise the process proceeds to block 1614.

At 1608, the UE determines whether the sidelink WUS is received within a sidelink WUS monitoring occasion in a first DRX cycle based on the second sidelink DRX configuration. In the context of FIGS. 1 and 5-15, for example, the UE 104/704 may perform the determination of the arrival time of the sidelink WUS. For instance, 1604 may be performed by one or more components described with respect to FIG. 4, e.g., controller/processor 459. The determination of whether the sidelink WUS is received within the sidelink WUS monitoring occasion may be performed, e.g., by the determination component 1842 through coordination with the monitoring component 1846 of the apparatus 1802 in FIG. 18. If the sidelink WUS is received within the sidelink WUS monitoring occasion, then the process proceeds to block 1612, otherwise the process proceeds to block 1616.

At 1610, the UE transitions into the sleep state in a second DRX cycle based on the sidelink WUS being received within the sidelink WUS monitoring occasion and the sidelink DRX configuration configuring the receiver UE with the first sidelink DRX configuration. In the context of FIGS. 1 and 5-15, for example, the UE 104/704 may perform the transition into the sleep state upon indication of the sidelink WUS. For instance, 1604 may be performed by one or more components described with respect to FIG. 4, e.g., controller/processor 459. The transition into the sleep state may be performed, e.g., by the DRX state transition component 1848 through coordination with the WUS component 1844 of the apparatus 1802 in FIG. 18.

Alternatively, at 1614, the UE refrains from transitioning into the sleep state during the second DRX cycle based on the sidelink WUS not being received within the sidelink WUS monitoring occasion and the sidelink DRX configuration configuring the receiver UE with the first sidelink DRX configuration. In this regard, the UE can monitor for sidelink data during a sidelink DRX on duration in the second DRX cycle. In the context of FIGS. 1 and 5-15, for example, the UE 104/704 may perform the refrain of transitioning into the sleep state after no detection of the sidelink WUS. For instance, 1604 may be performed by one or more components described with respect to FIG. 4, e.g., controller/processor 459. The refrain into the transition into the sleep state may be performed, e.g., by the DRX state transition component 1848 through coordination with the WUS component 1844 of the apparatus 1802 in FIG. 18.

At 1612, the UE transitions into the wakeup state in the second DRX cycle based on the sidelink WUS being received within the sidelink WUS monitoring occasion and the sidelink DRX configuration configuring the receiver UE with the second sidelink DRX configuration. In the context of FIGS. 1 and 5-15, for example, the UE 104/704 may perform the transition into the wakeup state upon indication of the sidelink WUS. For instance, 1604 may be performed by one or more components described with respect to FIG. 4, e.g., controller/processor 459. The transition into the wakeup state may be performed, e.g., by the DRX state transition component 1848 through coordination with the WUS component 1844 of the apparatus 1802 in FIG. 18.

Alternatively, at 1616, the UE refrains from transitioning into the wakeup state during the second DRX cycle based on the sidelink WUS not being received within the sidelink WUS monitoring occasion and the sidelink DRX configuration configuring the receiver UE with the second sidelink DRX configuration. In the context of FIGS. 1 and 5-15, for example, the UE 104/704 may perform the refrain of transitioning into the wakeup state after no detection of the sidelink WUS. For instance, 1604 may be performed by one or more components described with respect to FIG. 4, e.g., controller/processor 459. The refrain into the transition into the wakeup state may be performed, e.g., by the DRX state transition component 1848 through coordination with the WUS component 1844 of the apparatus 1802 in FIG. 18.

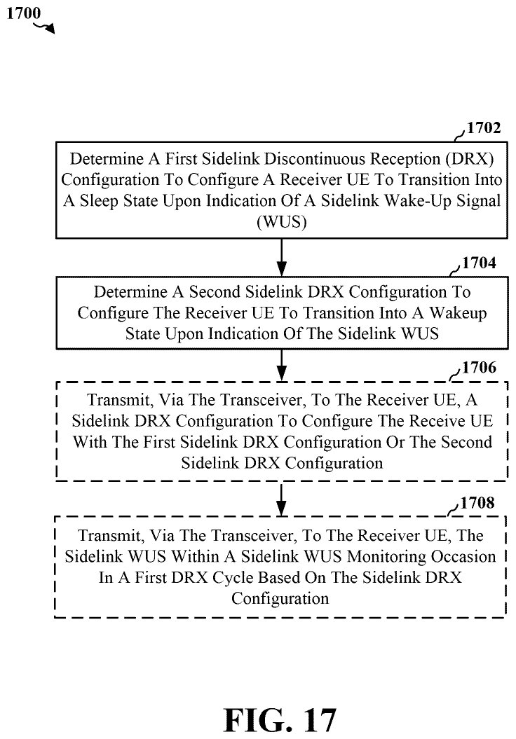

FIG. 17 is a flowchart 1700 illustrating a process of wireless communication that supports C-DRX enhancement with wakeup signal for sidelink communication at a transmitter UE in accordance with some aspects of the present disclosure. The process may be performed by a UE (e.g., UE 104, 450, 502, 504, 506, 508, 604). As illustrated, the flowchart 1700 includes a number of enumerated steps, but embodiments of the flowchart 1700 may include additional steps before, after, and in between the enumerated steps. In some embodiments, one or more of the enumerated steps may be omitted or performed in a different order. Optional aspects are illustrated with a dashed line.

At 1702, a UE (e.g., a transmitter UE) may determine a first sidelink DRX configuration to configure a receiver UE to transition into a sleep state upon indication of a sidelink WUS. In the context of FIGS. 1 and 5-15, for example, the UE 104/702 may determine the first sidelink DRX configuration. For instance, 1702 may be performed by one or more components described with respect to FIG. 4, e.g., controller/processor 459. The first sidelink DRX configuration may be determined, e.g., by the determination component 1842 through coordination with the DRX configuration component 1840 of the apparatus 1802 in FIG. 18.

At 1704, the transmitter UE may determine a second sidelink DRX configuration to configure a receiver UE to transition into a wakeup state upon indication of the sidelink WUS. In the context of FIGS. 1 and 5-15, for example, the UE 104/702 may determine the second sidelink DRX configuration. For instance, 1704 may be performed by one or more components described with respect to FIG. 4, e.g., controller/processor 459. The second sidelink DRX configuration may be determined, e.g., by the determination component 1842 through coordination with the DRX configuration component 1840 of the apparatus 1802 in FIG. 18.

At 1706, the transmitter UE may transmit, to the receiver UE, a sidelink DRX configuration to configure the receive UE with the first sidelink DRX configuration or the second sidelink DRX configuration. In the context of FIGS. 1 and 5-15, for example, the UE 104/702 may transmit the sidelink DRX configuration. For instance, 1706 may be performed by one or more components described with respect to FIG. 4, e.g., controller/processor 459, transmit processor 468, receiver/transmitter 454 and/or antenna 452. The sidelink DRX configuration may be transmitted, e.g., by the DRX configuration component 1840 via the transmission component 1834 of the apparatus 1802 in FIG. 18.

At 1708, the UE may transmit, to the receiver UE, the sidelink WUS within a sidelink WUS monitoring occasion in a first DRX cycle based on the sidelink DRX configuration. In the context of FIGS. 1 and 5-15, for example, the UE 104/702 may transmit the sidelink WUS. For instance, 1708 may be performed by one or more components described with respect to FIG. 4, e.g., controller/processor 459, transmit processor 468, receiver/transmitter 454 and/or antenna 452. The sidelink WUS may be transmitted, e.g., by the WUS component 1844 via the transmission component 1834 of the apparatus 1802 in FIG. 18.

FIG. 18 is a diagram 1800 illustrating an example of a hardware implementation for an apparatus 1802. The apparatus 1802 may be a UE or other wireless device that communicates based on sidelink. The apparatus 1802 includes a cellular baseband processor 1804 (also referred to as a modem) coupled to a cellular RF transceiver 1822 and one or more subscriber identity modules (SIM) cards 1820, an application processor 1806 coupled to a secure digital (SD) card 1808 and a screen 1810, a Bluetooth module 1812, a wireless local area network (WLAN) module 1814, a Global Positioning System (GPS) module 1816, and a power supply 1818. The cellular baseband processor 1804 communicates through the cellular RF transceiver 1822 with other wireless devices, such as a UE 104 and/or base station 102/180. The cellular baseband processor 1804 may include a computer-readable medium/memory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a sidelink communication manager 1832, and a transmission component 1834. The sidelink communication manager 1832 includes the one or more illustrated components. The components within the sidelink communication manager 1832 may be stored in the computer-readable medium/memory and/or configured as hardware within the cellular baseband processor 1804. The cellular baseband processor 1804 may be a component of the device 410 or 450 and may include the memory 460 or 476 and/or at least one of the TX processor 416 or 468, the RX processor 456 or 470, and the controller/processor 459 or 475. In one configuration, the apparatus 1802 may be a modem chip and include just the baseband processor 1804, and in another configuration, the apparatus 1802 may be the entire wireless device (e.g., see the device 410 or 450 of FIG. 4) and include the additional modules of the apparatus 1802.

The sidelink communication manager 1832 includes a DRX configuration component 1840, a determination component 1842, a WUS component 1844, a monitoring component 1846, and/or a DRX state transition component 1848 configured to perform the aspects described in connection with the processes in FIGS. 16 and 17. The apparatus is illustrated as including components to perform the processes of FIGS. 16 and 17, because the wireless device may operate as a transmitting device at times and may operate as a receiving device at other times.

The apparatus 1802 may include additional components that perform each of the blocks of the algorithms in the aforementioned flowcharts of FIGS. 16 and 17. As such, each block in the aforementioned flowcharts of FIGS. 16 and 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1802, and in particular the cellular baseband processor 1804, includes means for receiving, from a transmitter UE, a sidelink DRX configuration. The apparatus 1802 also may include means for determining whether the sidelink DRX configuration configures the receiver UE with a first sidelink DRX configuration or a second sidelink DRX configuration, the first sidelink DRX configuration configuring the receiver UE to transition into a sleep state upon indication of a sidelink WUS, the second sidelink DRX configuration configuring the receiver UE to transition into a wakeup state upon indication of the sidelink WUS. The apparatus 1802 also may include means for determining whether the sidelink WUS is received within a sidelink WUS monitoring occasion in a first DRX cycle based on the sidelink DRX configuration. The apparatus 1802 also may include means for transitioning into the sleep state in a second DRX cycle based on the sidelink WUS being received within the sidelink WUS monitoring occasion and the sidelink DRX configuration configuring the receiver UE with the first sidelink DRX configuration. The apparatus 1802 also may include means for transitioning into the wakeup state in the second DRX cycle based on the sidelink WUS being received within the sidelink WUS monitoring occasion and the sidelink DRX configuration configuring the receiver UE with the second sidelink DRX configuration.

In another configuration, the apparatus 1802, and in particular the cellular baseband processor 1804, includes means for determining a first sidelink DRX configuration to configure a receiver UE to transition into a sleep state upon indication of a sidelink WUS. The apparatus 1802 may also include means for transmitting, to a receiver UE over a sidelink channel, during at least a portion of a sidelink DRX active duration, a first message comprising an indication of the one or more first adjustments to the sidelink DRX configuration. The apparatus 1802 also may include means for determining a second sidelink DRX configuration to configure the receiver UE to transition into a wakeup state upon indication of the sidelink WUS. The apparatus 1802 also may include means for transmitting, to the receiver UE, a sidelink DRX configuration to configure the receive UE with the first sidelink DRX configuration or the second sidelink DRX configuration. The apparatus 1802 also may include means for transmitting, to the receiver UE, the sidelink WUS within a sidelink WUS monitoring occasion in a first DRX cycle based on the sidelink DRX configuration.

The aforementioned means may be one or more of the aforementioned components of the apparatus 1802 configured to perform the functions recited by the aforementioned means. As described supra, the apparatus 1802 may include the TX Processor 416 or 468, the RX Processor 456 or 470, and the controller/processor 459 or 475. As such, in one configuration, the aforementioned means may be the TX Processor 416 or 468, the RX Processor 456 or 470, and the controller/processor 459 or 475 configured to perform the functions recited by the aforementioned means.

The following aspects are illustrative only and aspects thereof may be combined with aspects of other examples or teaching described herein, without limitation.

Aspect 1 is an apparatus for wireless communication at a receiver user equipment (UE), comprising a memory; a transceiver; and at least one processor, coupled to the memory and the transceiver, configured to receive, via the transceiver, from a transmitter UE, a sidelink discontinuous reception (DRX) configuration; determine whether the sidelink DRX configuration configures the receiver UE with a first sidelink DRX configuration or a second sidelink DRX configuration, the first sidelink DRX configuration configuring the receiver UE to transition into a sleep state upon indication of a sidelink wake-up signal (WUS), the second sidelink DRX configuration configuring the receiver UE to transition into a wakeup state upon indication of the sidelink WUS; determine whether the sidelink WUS is received within a sidelink WUS monitoring occasion in a first DRX cycle based on the sidelink DRX configuration; transition into the sleep state in a second DRX cycle based on the sidelink WUS being received within the sidelink WUS monitoring occasion and the sidelink DRX configuration configuring the receiver UE with the first sidelink DRX configuration; and transition into the wakeup state in the second DRX cycle based on the sidelink WUS being received within the sidelink WUS monitoring occasion and the sidelink DRX configuration configuring the receiver UE with the second sidelink DRX configuration.

In Aspect 2, the apparatus of Aspect 1 further includes that the at least one processor is further configured to refrain from transitioning into the sleep state during the second DRX cycle based on the sidelink WUS not being received within the sidelink WUS monitoring occasion and the sidelink DRX configuration configuring the receiver UE with the first sidelink DRX configuration; and monitor for sidelink data during a sidelink DRX on-duration in the second DRX cycle.

In Aspect 3, the apparatus of any of Aspect 1 or Aspect 2 further includes that the at least one processor is further configured to refrain from transitioning into the wakeup state during the second DRX cycle based on the sidelink WUS not being received within the sidelink WUS monitoring occasion and the sidelink DRX configuration configuring the receiver UE with the second sidelink DRX configuration.

In Aspect 4, the apparatus of any of Aspects 1-3 further includes that the at least one processor is further configured to determine one or more failures of a listen-before-talk (LBT) procedure prior to monitoring for the sidelink WUS in the first DRX cycle, wherein the refrain from transitioning into the wakeup state is further based on the determined one or more failures of the LBT procedure.

In Aspect 5, the apparatus of any of Aspects 1-4 further includes that the at least one processor is further configured to determine one or more failures of a LBT procedure prior to monitoring for the sidelink WUS in the first DRX cycle, wherein the transition into the wakeup state occurs irrespective of the determined one or more failures of the LBT procedure.

In Aspect 6, the apparatus of any of Aspects 1-5 further includes that the at least one processor is further configured to determine that the receiver UE cannot monitor for the sidelink WUS in the first DRX cycle prior to a next sidelink DRX on-duration in the second DRX cycle based on the receiver UE being scheduled to transmit a sidelink communication to a third UE during the sidelink WUS monitoring occasion, wherein the receiver UE assumes that the transmitter UE sends the sidelink WUS during the sidelink WUS monitoring occasion; transition into the wakeup state during the second DRX cycle; and monitor for sidelink data during the next sidelink DRX on-duration.

7 In Aspect 7, the apparatus of any of Aspects 1-6 further includes that the receiver UE skips being in an active state during a first sidelink DRX on-duration in the second DRX cycle when the receiver UE transitions into the sleep state and remains in the sleep state until a second sidelink DRX on-duration in a third DRX cycle.

In Aspect 8, the apparatus of any of Aspects 1-7 further includes that the at least one processor is further configured to receive, from the transmitter UE, within the sidelink WUS monitoring occasion, sidelink control information (SCI) comprising the sidelink WUS.

In Aspect 9, the apparatus of Aspect 8 further includes that the SCI includes a transmission structure that includes the sidelink WUS without data.

In Aspect 10, the apparatus of Aspect 8 further includes that the SCI includes a transmission structure that includes the sidelink WUS with data.

In Aspect 11, the apparatus of Aspect 10 further includes that the sidelink WUS monitoring occasion is embedded within a sidelink DRX on-duration.

In Aspect 12, the apparatus of Aspect 11 further includes that the sidelink DRX configuration configures a first type of sidelink DRX on-duration and a second type of sidelink DRX on-duration different than the first type of sidelink DRX on-duration, wherein the sidelink DRX configuration indicates which of the first type of sidelink DRX on-duration or the second type of sidelink DRX on-duration is configured to support mini-slot transmission, wherein the at least one processor is further configured to monitor for the SCI during one or more mini slots of the sidelink WUS monitoring occasion in the first type of sidelink DRX on-duration or the second type of sidelink DRX on-duration.

In Aspect 13, the apparatus of Aspect 10 further includes that the sidelink WUS monitoring occasion is outside of a sidelink DRX on-duration within a DRX cycle.

In Aspect 14, the apparatus of Aspect 13 further includes that the sidelink DRX configuration configures a location of the sidelink WUS monitoring occasion by an offset between a start of a sidelink WUS monitoring window and a duration spanning the sidelink WUS monitoring window, wherein an end of the sidelink WUS monitoring window and a start of a sidelink DRX on-duration are separated by a minimum gap based on the offset and the duration.

In Aspect 15, the apparatus of Aspect 14 further includes that the sidelink WUS monitoring window comprises a plurality of candidate sidelink WUS monitoring occasions, wherein the duration comprises a plurality of mini slots, wherein each candidate sidelink WUS monitoring occasion of the plurality of candidate sidelink WUS monitoring occasions corresponds to one mini slot of the plurality of mini slots.

In Aspect 16, the apparatus of any of Aspects 1-15 further includes that the first sidelink DRX configuration is associated with a first type of sidelink DRX on-duration and the second sidelink DRX configuration is associated with a second type of sidelink DRX on-duration different than the first type of sidelink DRX on-duration.

In Aspect 17, the apparatus of Aspect 16 further includes that the receiver UE transitions into the sleep state based on the first sidelink DRX configuration when the sidelink WUS is received during the first type of sidelink on duration.

In Aspect 18, the apparatus of Aspect 16 further includes that the receiver UE transitions into the wakeup state based on the second sidelink DRX configuration when the sidelink WUS is received during the second type of sidelink on duration.

In Aspect 19, the apparatus of any of Aspects 1-18 further includes that the at least one processor is further configured to receive, from the transmitter UE, within a first sidelink WUS monitoring occasion, the sidelink WUS, wherein the sidelink WUS indicates to the receiver UE to transition into the sleep state or the wakeup state for one or more sidelink DRX on-duration following indication of the sidelink WUS; and refrain from monitoring for a second sidelink WUS monitoring occasion subsequent to the first sidelink WUS monitoring occasion when a sidelink DRX on-duration corresponding to the second sidelink WUS monitoring occasion is to transition into the sleep state or the wakeup state.

In Aspect 20, the apparatus of Aspect 8 further includes that the SCI includes an indication of a destination identifier to indicate which receiver UE or set of receiver UEs are to transition into the wakeup state or the sleep state.

In Aspect 21, the apparatus of Aspect 20 further includes that the SCI includes a plurality of stages of which a second stage of the plurality of stages carries one or more information blocks in an order based on the destination identifier of each corresponding receiver UE within a group of receiver UEs, wherein each of the one or more information blocks is intended for a specific receiver UE within the group of receiver UEs.

In Aspect 22, the apparatus of Aspect 21 further includes that at least one of the one or more information blocks indicates the sidelink WUS and further indicates a number of bits corresponding to a number of sidelink DRX on-duration instances for the specific receiver UE to transition into the sleep state or the wakeup state.

In Aspect 23, the apparatus of Aspect 22 further includes that the number of bits is arranged in a bitmap with each location of the bitmap indicating a different number of sidelink DRX on-duration instances.

In Aspect 24, the apparatus of Aspect 22 further includes that the number of bits corresponds to a plurality of indices with each index of the plurality of indices indicating a different number of sidelink DRX on-duration instances.

In Aspect 25, the apparatus of Aspect 22 further includes that the number of bits is arranged in a start and length indicator value (SLIV) that indicates an index for a starting sidelink DRX on-duration and a number of continuous indices corresponding to sidelink DRX on-duration instances.

In Aspect 26, the apparatus of Aspect 20 further includes that the SCI includes a plurality of stages of which a third stage of the plurality of stages carries one or more information blocks in an order based on the destination identifier of each corresponding receiver UE within a group of receiver UEs, wherein each of the one or more information blocks is intended for a specific receiver UE within the group of receiver UEs.

In Aspect 27, the apparatus of Aspect 26 further includes that a second stage of the plurality of stages includes an indication of whether the third stage of the plurality of stages is being transmitted.

In Aspect 28, the apparatus of Aspect 20 further includes that the SCI includes a plurality of stages of which a first stage of the plurality of stages includes an indication of whether the sidelink WUS is being transmitted.

In Aspect 29, the apparatus of any of Aspects 1-28 further includes that the sidelink WUS is associated with a fixed resource in every N subchannels where N is a positive integer, wherein the sidelink WUS is received on the fixed resource within the sidelink WUS monitoring occasion based on the sidelink WUS having a first priority greater than a second priority of a reservation for the fixed resource by another transmitter UE.

In Aspect 30, the apparatus of any of Aspects 1-29 further includes receiving a physical sidelink feedback channel (PSFCH) comprising the sidelink WUS within the sidelink WUS monitoring occasion, wherein the sidelink WUS monitoring occasion is embedded within a sidelink DRX on-duration or located outside of the sidelink DRX on-duration.

In Aspect 31, the apparatus of Aspect 30 further includes that a location of the sidelink WUS monitoring occasion is configured by a first PSFCH resource pool that is separate from a second PSFCH resource pool for conflict indication and feedback signaling.

In Aspect 32, the apparatus of Aspect 31 further includes that the first PSFCH resource pool and the second PSFCH resource pool include PSFCH resources with separate physical resource blocks (PRBs), wherein the sidelink WUS monitoring occasion and the conflict indication and feedback signaling are allocated to the PSFCH in a same time slot using different PRBs.

In Aspect 33, the apparatus of Aspect 31 further includes that the first PSFCH resource pool and the second PSFCH resource pool include PSFCH resources with multiple time slots, wherein the sidelink WUS monitoring occasion is allocated to a first PSFCH and the conflict indication and the feedback signaling are allocated to a second PSFCH in different time slots using a different number of physical resource blocks (PRBs), wherein the first PSFCH has a first periodicity that is greater than a second periodicity of the second PSFCH.

In Aspect 34, the apparatus of Aspect 30 further includes that a location of the sidelink WUS monitoring occasion is configured by a PFSCH resource pool that is common with feedback signaling, wherein the sidelink WUS monitoring occasion and the feedback signaling are allocated to same physical resource blocks (PRBs) using different cyclic shift pairs.

In Aspect 35, the apparatus of Aspect 30 further includes that the PSFCH comprises a plurality of sets of physical resource blocks (PRBs) that is split by a number of sidelink DRX on-duration instances of which an order of each set of PRBs of the plurality of sets PRBs is aligned with a corresponding sidelink DRX on-duration instance in time, wherein each set of PRBs of the plurality of sets PRBs includes one or more PRBs mapped with an indication of the sidelink WUS based on a destination identifier corresponding to the receiver UE.

In Aspect 36, the apparatus of Aspect 30 further includes that the sidelink DRX configuration indicates that the sidelink WUS monitoring occasion is located in a PSFCH occasion that is nearest in position to a next sidelink DRX on-duration than other PSFCH occasions.

In Aspect 37, the apparatus of Aspect 36 further includes that the sidelink DRX configuration indicates that the sidelink WUS monitoring occasion is located in a first PSFCH occasion that is nearest in position to the next sidelink DRX on-duration than a second PSFCH occasion or is located in the second PSFCH occasion that is second nearest in position to the next sidelink DRX on-duration, wherein the at least one processor is further configured to monitor for the PSFCH in the second PSFCH occasion and monitor for the PSFCH in the first PSFCH occasion when the PSFCH is not detected in the second PSFCH occasion.

Aspect 38 is a device including one or more processors and one or more memories in electronic communication with the one or more processors storing instructions executable by the one or more processors to cause the device to realize an apparatus as in any of Aspects 1-37.

Aspect 39 is a system or apparatus including means for implementing a method or realizing an apparatus as in any of Aspects 1-37.

Aspect 40 is a non-transitory computer readable medium storing instructions executable by one or more processors to cause the one or more processors to realize an apparatus as in any of Aspects 1-37.

Aspect 41 is a method to realize an apparatus as in any of Aspects 1-37.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. An apparatus for wireless communication at a receiver user equipment (UE), comprising:
a memory;
a transceiver; and
at least one processor, coupled to the memory and the transceiver, configured to:
receive, via the transceiver, from a transmitter UE, a sidelink discontinuous reception (DRX) configuration;
determine whether the sidelink DRX configuration configures the receiver UE with a first sidelink DRX configuration or a second sidelink DRX configuration, the first sidelink DRX configuration configuring the receiver UE to transition into a sleep state upon indication of a sidelink wake-up signal (WUS), the second sidelink DRX configuration configuring the receiver UE to transition into a wakeup state upon indication of the sidelink WUS;
determine whether the sidelink WUS is received within a sidelink WUS monitoring occasion in a first DRX cycle based on the sidelink DRX configuration; and
transition into the sleep state in a second DRX cycle based on the sidelink WUS being received within the sidelink WUS monitoring occasion and the sidelink DRX configuration configuring the receiver UE with the first sidelink DRX configuration, or transition into the wakeup state in the second DRX cycle based on the sidelink WUS being received within the sidelink WUS monitoring occasion and the sidelink DRX configuration configuring the receiver UE with the second sidelink DRX configuration.

2. The apparatus of claim 1, wherein the at least one processor is further configured to:
refrain from transitioning into the sleep state during the second DRX cycle based on the sidelink WUS not being received within the sidelink WUS monitoring occasion and the sidelink DRX configuration configuring the receiver UE with the first sidelink DRX configuration; and
monitor for sidelink data during a sidelink DRX on-duration in the second DRX cycle.

3. The apparatus of claim 1, wherein the at least one processor is further configured to:
refrain from transitioning into the wakeup state during the second DRX cycle based on the sidelink WUS not being received within the sidelink WUS monitoring occasion and the sidelink DRX configuration configuring the receiver UE with the second sidelink DRX configuration.

4. The apparatus of claim 1, wherein the at least one processor is further configured to:
determine that the receiver UE cannot monitor for the sidelink WUS in the first DRX cycle prior to a next sidelink DRX on-duration in the second DRX cycle based on the receiver UE being scheduled to transmit a sidelink communication to a third UE during the sidelink WUS monitoring occasion, wherein the receiver UE assumes that the transmitter UE sends the sidelink WUS during the sidelink WUS monitoring occasion;
transition into the wakeup state during the second DRX cycle; and
monitor for sidelink data during the next sidelink DRX on-duration.

5. The apparatus of claim 1, wherein the receiver UE skips being in an active state during a first sidelink DRX on-duration in the second DRX cycle when the receiver UE transitions into the sleep state and remains in the sleep state until a second sidelink DRX on-duration in a third DRX cycle.

6. The apparatus of claim 1, wherein the sidelink WUS is associated with a fixed resource in every N subchannels where N is a positive integer, wherein the sidelink WUS is received on the fixed resource within the sidelink WUS monitoring occasion based on the sidelink WUS having a first priority greater than a second priority of a reservation for the fixed resource by another transmitter UE.

7. The apparatus of claim 1, wherein the at least one processor is further configured to:
receive, from the transmitter UE, within a first sidelink WUS monitoring occasion, the sidelink WUS, wherein the sidelink WUS indicates to the receiver UE to transition into the sleep state or the wakeup state for one or more sidelink DRX on-duration instances following indication of the sidelink WUS; and
refrain from monitoring for a second sidelink WUS monitoring occasion subsequent to the first sidelink WUS monitoring occasion when a sidelink DRX on-duration corresponding to the second sidelink WUS monitoring occasion is to transition into the sleep state or the wakeup state.

8. The apparatus of claim 1, wherein the at least one processor is further configured to:
receive, from the transmitter UE, within the sidelink WUS monitoring occasion, sidelink control information (SCI) comprising the sidelink WUS.

9. The apparatus of claim 8, wherein the SCI includes a transmission structure that includes the sidelink WUS without data.

10. The apparatus of claim 8, wherein the SCI includes a transmission structure that includes the sidelink WUS with data.

11. The apparatus of claim 10, wherein the sidelink WUS monitoring occasion is embedded within a sidelink DRX on-duration, wherein the sidelink DRX configuration configures a first type of sidelink DRX on-duration and a second type of sidelink DRX on-duration different than the first type of sidelink DRX on-duration, wherein the sidelink DRX configuration indicates which of the first type of sidelink DRX on-duration or the second type of sidelink DRX on-duration is configured to support mini-slot transmission, wherein the at least one processor is further configured to:
monitor for the SCI during one or more mini slots of the sidelink WUS monitoring occasion in the first type of sidelink DRX on-duration or the second type of sidelink DRX on-duration.

12. The apparatus of claim 10, wherein the sidelink WUS monitoring occasion is outside of a sidelink DRX on-duration within a DRX cycle.

13. The apparatus of claim 12, wherein the sidelink DRX configuration configures a location of the sidelink WUS monitoring occasion by an offset between a start of a sidelink WUS monitoring window and a duration spanning the sidelink WUS monitoring window, wherein an end of the sidelink WUS monitoring window and a start of a sidelink DRX on-duration are separated by a minimum gap based on the offset and the duration, wherein the sidelink WUS monitoring window comprises a plurality of candidate sidelink WUS monitoring occasions, wherein the duration comprises a plurality of mini slots, wherein each candidate sidelink WUS monitoring occasion of the plurality of candidate sidelink WUS monitoring occasions corresponds to one mini slot of the plurality of mini slots.

14. The apparatus of claim 1, wherein the first sidelink DRX configuration is associated with a first type of sidelink DRX on-duration and the second sidelink DRX configuration is associated with a second type of sidelink DRX on-duration different than the first type of sidelink DRX on-duration.

15. The apparatus of claim 14, wherein the receiver UE transitions into the sleep state based on the first sidelink DRX configuration when the sidelink WUS is received during the first type of sidelink on duration.

16. The apparatus of claim 14, wherein the receiver UE transitions into the wakeup state based on the second sidelink DRX configuration when the sidelink WUS is received during the second type of sidelink on duration.

17. The apparatus of claim 8, wherein the SCI includes an indication of a destination identifier to indicate which receiver UE or set of receiver UEs are to transition into the wakeup state or the sleep state.

18. The apparatus of claim 17, wherein the SCI includes a plurality of stages of which a second stage of the plurality of stages carries one or more information blocks in an order based on the destination identifier of each corresponding receiver UE within a group of receiver UEs, wherein each of the one or more information blocks is intended for a specific receiver UE within the group of receiver UEs, wherein at least one of the one or more information blocks indicates the sidelink WUS and further indicates a number of bits corresponding to a number of sidelink DRX on-duration instances for the specific receiver UE to transition into the sleep state or the wakeup state.

19-30. (canceled)

31. A method of wireless communication performed by a receiver user equipment (UE), the method comprising:
receiving, from a transmitter UE, a sidelink discontinuous reception (DRX) configuration;
determining whether the sidelink DRX configuration configures the receiver UE with a first sidelink DRX configuration or a second sidelink DRX configuration, the first sidelink DRX configuration configuring the receiver UE to transition into a sleep state upon indication of a sidelink wake-up signal (WUS), the second sidelink DRX configuration configuring the receiver UE to transition into a wakeup state upon indication of the sidelink WUS;
determining whether the sidelink WUS is received within a sidelink WUS monitoring occasion in a first DRX cycle based on the sidelink DRX configuration; and
transitioning into the sleep state in a second DRX cycle based on the sidelink WUS being received within the sidelink WUS monitoring occasion and the sidelink DRX configuration configuring the receiver UE with the first sidelink DRX configuration, or transitioning into the wakeup state in the second DRX cycle based on the sidelink WUS being received within the sidelink WUS monitoring occasion and the sidelink DRX configuration configuring the receiver UE with the second sidelink DRX configuration.

32-33. (canceled)
